(19) United States
(12) Patent Application Publication
(10) Pub. No.: US 2026/0288821 A1
(43) Pub. Date: Sep. 24, 2026

(54) SYSTEMS AND METHODS FOR VISUAL QUESTION-ANSWERING IN SOCCER USING A MULTIMODAL MODEL

(71) Applicant: Stats LLC, Chicago, IL (US)

(72) Inventors: Harry HUGHES, Brisbane (AU); Michael John HORTON, Wellington (NZ); Patrick Joseph LUCEY, Chicago, IL (US)

(73) Assignee: Stats LLC, Chicago, IL (US)

(21) Appl. No.: 19/568,011

(22) Filed: Mar. 16, 2026

Related U.S. Application Data
(60) Provisional application No. 63/774,355, filed on Mar. 19, 2025.

(51) Int. Cl. G06F 16/3329; G06V 20/40

(52) U.S. Cl. CPC G06F 16/33295; G06V 20/42

(57) ABSTRACT

Systems and methods related to a computing system for generating query responses, the computing system configured to generate a tracking data feed based on a broadcast feed of a sporting occasion, receive a query corresponding to an event in the sporting occasion, receive event data related to the sporting occasion, translate the query into one or more tokens, and, based on the tracking data feed, the event data, and the one or more tokens, determine a response to the query, wherein the response is based on a likelihood of the event occurring.

### CROSS-REFERENCE TO RELATED APPLICATIONS

This application claims the benefit of U.S. Provisional Patent Application 63/774,355 filed Mar. 19, 2025, the contents of which are incorporated herein by reference for all purposes. Further, application incorporates by reference the content of U.S. Provisional Patent Application 63/913,529 filed Nov. 7, 2025.

### FIELD OF INVENTION

The present disclosure relates to training and implementing machine learning for sports applications, and more particularly to systems and methods for visual question-answering in sports using a multimodal model that processes tracking data and event data to perform actions based on questions about sporting occasions.

### BACKGROUND

Sports analytics has evolved substantially with the advancement of machine learning technologies and data collection systems. Modern sporting occasions (games, etc.) generate vast amounts of data through various tracking systems, including optical tracking, wearable sensors, and broadcast video analysis. This data encompasses player movements, ball trajectories, game events, and contextual information that can provide insights into performance, strategy, and predictive outcomes. The integration of artificial intelligence and machine learning models has enabled the processing of these large-scale datasets to extract meaningful patterns and generate actionable insights for teams, broadcasters, and fans.

Visual question answering (VQA) represents an area of artificial intelligence where systems are tasked with providing natural language answers to natural language questions about images or video content. The application of VQA approaches to sports analytics presents particular challenges that differ from general-purpose visual understanding tasks.

In sports contexts, particularly in team sports such as soccer, on-ball actions and game events are not typically defined using natural language. Instead, these actions are characterized using structured event data that specifies the semantic context of each on-ball action during gameplay. Commercial event data is widely available across professional sports leagues and is typically labeled by human annotators to ensure accuracy for media and betting applications. This structured representation of sporting events creates a disconnect between conventional natural language-based VQA approaches and the domain-specific language used to describe and analyze sporting actions.

Using raw video footage to track agents, objects, etc. presents substantial computational challenges when used as input for sports analytics systems. Video data contains enormous amounts of visual information that must be processed to extract meaningful positional data, requiring significant computational resources and processing time. The high dimensionality of video frames, combined with the need to process footage at high framerates throughout an entire game, creates bottlenecks in analysis pipelines. These challenges make analysis from raw video footage impractical for real-time or near real-time sports analytics applications.

Existing approaches to answering predictive questions in sports analytics have been limited by their fragmentation. Prior methods have formulated individual questions as separate prediction tasks, each requiring its own data pipeline, neural network architecture, hyperparameter optimization, and model training. For example, separate specialized systems have been developed to predict the intended receiver of a pass, the likelihood of pass success, the probability that shots will lead to goals, and other event-specific outcomes. This inflexibility becomes prohibitive when attempting to extend methods across the numerous types of questions that arise in sports analysis.

The computational challenges associated with processing comprehensive sports datasets also remain substantial. Traditional approaches to sports data analysis often struggle with the scale and complexity of modern tracking data, which can include millions of data points per game across multiple modalities such as positional tracking, event sequences, and temporal relationships. The application of transformer-based neural networks to sports analytics presents both opportunities and computational constraints, particularly when attempting to process entire games rather than limited time windows.

Unless otherwise indicated herein, the techniques and information described in this section are not prior art to the claims in this application and are not admitted to be prior art, or suggestions of the prior art, by inclusion in this section.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to a computing system for generating query responses, the system comprising a processor and memory storing instructions that, when executed by the processor, cause the processor to perform acts. The acts comprise generating, by the computing system, a tracking data feed based on a broadcast feed of a sporting occasion, the tracking data feed having position information including x,y coordinates of one or more agents and x,y coordinates of one or more objects, wherein the position information of one or more agents and one or more objects from the broadcast feed is projected onto a two-dimensional playing surface including the x,y coordinates, receiving, by the computing system, a query corresponding to an event in the sporting occasion, receiving, by the computing system, event data related to the sporting occasion, translating, by the computing system, the query into one or more tokens, and, based on the tracking data feed, the event data, and the one or more tokens, determining, by the computing system, a response to the query, wherein the response is based on a likelihood of the event occurring.

In some aspects, the techniques described herein relate to the computing system, wherein the query includes at least one of an event identifier, a team identifier, a player identifier, a target identifier, and an outcome identifier.

In some aspects, the techniques described herein relate to the computing system, wherein the one or more tokens further include tokens representing at least one of the event identifier, the team identifier, the player identifier, the target identifier, and the outcome identifier.

In some aspects, the techniques described herein relate to the computing system, wherein the one or more tokens include a start of sequence (SOS) token and an end of sequence (EOS) token.

In some aspects, the techniques described herein relate to the computing system, wherein the query comprises natural language generated by a user.

In some aspects, the techniques described herein relate to the computing system, wherein the processor further performs acts comprising receiving, by the computing system, a second query corresponding to the even translating, by the computing system, the second query into one or more tokens, and, based on the tracking data feed and the one or more tokens, determining, by the computing system, a second response to the query, wherein the second response is based on the likelihood of the event occurring and a feature related to the event, the feature being one of a player, a team, a target, and an outcome.

In some aspects, the techniques described herein relate to the computing system, wherein the processor further performs acts comprising receiving, by the computing system, a third query corresponding to the event, translating, by the computing system, the third query into one or more tokens, and, based on the tracking data feed and the one or more tokens, determining, by the computing system, a third response to the query, wherein the third response is based on the likelihood of the event occurring and a second feature related to the event, the feature being one of a player, a team, a target, and an outcome.

In some aspects, the techniques described herein relate to the computing system, wherein the one or more tokens represent numerical values.

In some aspects, the techniques described herein relate to a computer-implemented method for generating query responses, comprising generating a tracking data feed based on a broadcast feed of a sporting occasion, the tracking data feed having position information including x,y coordinates of one or more agents and x,y coordinates one or more objects, wherein the position information of one or more agents and one or more objects from the broadcast feed is projected onto a two-dimensional playing surface including the x,y coordinates, receiving a query corresponding to an event in the sporting occasion, receiving event data related to the sporting occasion, translating the query into one or more tokens, and, based on the tracking data feed, the event data, and the one or more tokens, determining a response to the query, wherein the response is based on a likelihood of the event occurring.

In some aspects, the techniques described herein relate to the computer-implemented method, wherein the query includes at least one of an event identifier, a team identifier, a player identifier, a target identifier, and an outcome identifier.

In some aspects, the techniques described herein relate to the computer-implemented method, wherein the one or more tokens further include tokens representing at least one of the event identifier, the team identifier, the player identifier, the target identifier, and the outcome identifier.

In some aspects, the techniques described herein relate to the computer-implemented method, wherein the one or more tokens include a start of sequence (SOS) token and an end of sequence (EOS) token.

In some aspects, the techniques described herein relate to the computer-implemented method, further comprising: receiving a second query corresponding to the event; translating the second query into one or more tokens; and based on the tracking data feed and the one or more tokens, determining a second response to the query, wherein the second response is based on the likelihood of the event occurring and a feature related to the event, the feature being one of a player, a team, a target, and an outcome.

In some aspects, the techniques described herein relate to the computer-implemented method, further comprising: receiving a third query corresponding to the event; translating the third query into one or more tokens; and based on the tracking data feed and the one or more tokens, determining a third response to the query, wherein the third response is based on the likelihood of the event occurring and a second feature related to the event, the second feature being one of a player, a team, a target, and an outcome.

In some aspects, the techniques described herein relate to a non-transitory computer readable medium configured to store processor-readable instructions, wherein, when executed by a processor, the instructions perform operations comprising generating a tracking data feed based on a broadcast feed of a sporting occasion, the tracking data feed having position information including x,y coordinates of one or more agents and x,y coordinates one or more objects, wherein the position information of one or more agents and one or more objects from the broadcast feed is projected onto a two-dimensional playing surface including the x,y coordinates, receiving a query corresponding to an event in the sporting occasion, receiving event data related to the sporting occasion, translating the query into one or more tokens, and, based on the tracking data feed, the event data, and the one or more tokens, determining a response to the query, wherein the response is based on a likelihood of the event occurring.

In some aspects, the techniques described herein relate to the non-transitory computer readable medium, wherein the query includes at least one of an event identifier, a team identifier, a player identifier, a target identifier, and an outcome identifier.

In some aspects, the techniques described herein relate to the non-transitory computer readable medium, wherein the one or more tokens further include tokens representing at least one of the event identifier, the team identifier, the player identifier, the target identifier, and the outcome identifier.

In some aspects, the techniques described herein relate to the non-transitory computer readable medium, wherein the one or more tokens include a start of sequence (SOS) token and an end of sequence (EOS) token.

In some aspects, the techniques described herein relate to the non-transitory computer readable medium, wherein the processor further performs acts comprising receiving a second query corresponding to the event, translating the second query into one or more tokens, and, based on the tracking data feed and the one or more tokens, determining a second response to the query, wherein the second response is based on the likelihood of the event occurring and a feature related to the event, the feature being one of a player, a team, a target, and an outcome.

In some aspects, the techniques described herein relate to the non-transitory computer readable medium, wherein the processor further performs acts comprising receiving a third query corresponding to the event, translating the third query into one or more tokens, and, based on the tracking data feed and the one or more tokens, determining a third response to the query, wherein the third response is based on the likelihood of the event occurring and a second feature related to the event, the feature being one of a player, a team, a target, and an outcome.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an exemplary computing environment for generating query responses related to sporting occasions, according to aspects of the present disclosure.

FIG. 2 illustrates a block diagram of a multi-modal language model, according to aspects of the present disclosure.

FIG. 3 illustrates an example of event data as converted to an Event Query Language prompt, according to aspects of the present disclosure.

FIG. 4 illustrates charts of example inputs and outputs of the multi-modal language model of FIG. 2, according to aspects of the present disclosure.

FIG. 5 illustrates a first embodiment of the multi-modal language model architecture of FIG. 2, according to aspects of the present disclosure.

FIG. 6 illustrates a first block diagram of a sporting occasion and outputs of the multi-modal language model of FIG. 2, according to aspects of the present disclosure.

FIG. 7 illustrates a second block diagram of a sporting occasion and outputs of the multi-modal language model of FIG. 2, according to aspects of the present disclosure.

FIG. 8 illustrates a second embodiment of the multi-modal language model architecture of FIG. 2, according to aspects of the present disclosure.

FIG. 9 illustrates a tokenization process for tracking data, according to aspects of the present disclosure.

FIG. 10 illustrates a codebook for tokenizing tracklets, according to aspects of the present disclosure.

FIG. 11 illustrates a graph of a reliability plot, according to aspects of the present disclosure.

FIG. 12 illustrates a graph of relative calibration error by category, according to aspects of the present disclosure.

FIG. 13 illustrates a block diagram of training the multi-modal language model of FIG. 2, according to aspects of the present disclosure.

FIG. 14 illustrates a flowchart of a process for generating query responses, according to aspects of the present disclosure.

FIG. 15 illustrates a flowchart of a process for training the multi-modal language model of FIG. 2, according to aspects of the present disclosure.

FIG. 16 illustrates a flowchart of another process for generating query responses, according to aspects of the present disclosure.

FIG. 17 illustrates a flow diagram of training a multi-modal language model, according to aspects of the present disclosure.

FIG. 18A illustrates a first block diagram illustrating a computing device, according to aspects of the present disclosure.

FIG. 18B illustrates a second block diagram illustrating a computing device, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Conventional approaches to sports analytics may suffer from fragmentation, where each predictive question about a sporting occasion requires a separate data pipeline, a distinct neural network architecture, independent hyperparameter optimization, and dedicated model training. For example, predicting the intended receiver of a pass may require one specialized model, while predicting the likelihood of a pass being successful may require a completely different model with its own training regimen. This fragmentation may create substantial computational overhead and may limit the flexibility with which questions can be answered. Furthermore, conventional approaches may predominantly focus on predicting the next immediate event and may lack the capacity to answer nested questions that relate to events occurring further in the future. This limitation to conventional approaches may restrict the ability to quantitatively model the longer-term impacts of player actions, as questions that condition on hypothetical sequences of future events cannot be addressed by systems that only predict the next immediate event.

Another technical challenge in sports analytics may involve the use of raw video footage as input data. While video footage may contain information about agent locations and movements, video data may represent a high-dimensional data stream that may be computationally expensive to process. The computational burden of processing raw video may limit the practical applicability of video-based approaches for real-time or near real-time analysis of sporting occasions.

A computing system for generating query responses may address these technical challenges by providing a framework for answering diverse event-centric questions and performing downstream actions using the framework. Rather than requiring separate architectures for each question type, the computing system may implement a multi-modal language model that answers a wide range of predictive questions through a single unified model. The computing system may receive tracking data as input, where tracking data may specify two-dimensional center-of-mass locations of agents (such as players) and objects (such as a ball) at a high framerate throughout a sporting occasion. Tracking data may represent a compressed and tractable data stream compared to raw video footage while containing similar underlying information about agent locations.

The computing system may further generate or receive queries and event data formulated using a tokenized Event Query Language (EQL). EQL may provide a standardized structure (e.g., prompt) for expressing queries and event data as sequences of discrete language tokens. Each prompt in EQL may be represented using tokens that specify attributes such as event category or identifier, team, player, target, and outcome. The computing system may process the tracking data, queries, and event data to generate responses that indicate likelihoods of events occurring and to perform downstream actions.

Downstream actions may include triggering advertisements, graphics, highlights, or animations based on predicted events during a broadcast. Downstream actions may further include stopping or suspending market predictions when predicted event likelihoods reach predetermined thresholds, switching between video streams in a multi-game broadcast environment based on predicted exciting events, and/or performing integrity monitoring to detect anomalous patterns by comparing predicted event likelihoods with observed market activity. The computing system may also generate ghosting predictions that display predicted future player locations on a playing surface representation, enabling visualization of potential player movements and strategic positioning scenarios for coaching and analysis applications.

The computing system may employ spatiotemporal axial attention as a mechanism for encoding tracking data. Spatiotemporal axial attention may decompose self-attention into separate temporal and spatial operations. When applied to tracking data, standard self-attention may have memory and runtime complexity of O(T²E²), where T represents the number of time frames and E represents the number of entities. In contrast, spatiotemporal axial attention may have complexity of O(ET²+TE²), which may provide improved asymptotic complexity compared to standard self-attention. This reduced computational complexity enables the computing system to process longer sequences of tracking data, allowing analysis of complete sporting occasions rather than being limited to short time windows.

The computing system may output responses to the queries based on predicted likelihoods of events occurring. The responses may address questions about event categories, teams involved, players completing actions, intended targets of passes, outcomes of events, etc. The computing system may further answer nested questions that condition on hypothetical sequences of future events, enabling analysis of the longer-term impacts of player actions.

The computing system may represent a specialized computer technology that improves the technical field of sports data processing through its unified architecture and efficient attention mechanisms. By implementing spatiotemporal axial attention, the computing system achieves a technical improvement in computational efficiency that enables processing of complete sporting occasions on standard computing hardware, whereas conventional approaches using standard self-attention would require substantially greater computational resources or would be limited to processing shorter time windows. The Event Query Language provides a technical solution for bridging the gap between natural language queries and structured sports event data, enabling a single trained model to answer diverse question types without requiring separate model architectures, data pipelines, or training procedures for each question category. This technical architecture reduces memory consumption and processing time compared to systems that would otherwise require multiple specialized models operating in parallel, thereby improving the functioning of the computer system itself when applied to sports analytics tasks.

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value. In this disclosure, unless stated otherwise, any numeric value may include a possible variation of +10% in the stated value.

The terminology used below may be interpreted in its broadest reasonable manner, even though the terminology is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

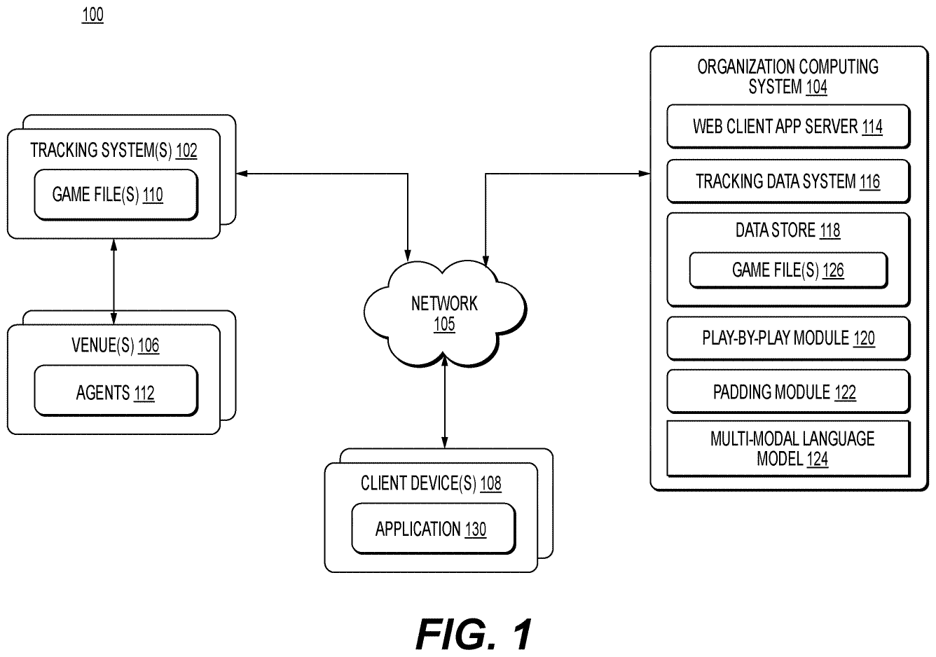

FIG. 1 is a block diagram illustrating a computing environment 100, according to example embodiment. The computing environment 100 may include a tracking system 102 (e.g., positioned at or in communication with one or more components positioned at a venue 106), an organization computing system 104, and one or more client devices 108 communicating via a network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of computing environment 100.

Tracking system 102 may be positioned in venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents 112 (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras (e.g., ariel cameras, wearable cameras, vehicle-mounted cameras, handheld cameras, etc.), one or more panoramic cameras, etc. For example, a system of six calibrated cameras (e.g., fixed cameras), which project three-dimensional locations of players and a ball onto a two-dimensional overhead view of the playing surface may be used. In another example, a mix of stationery and non-stationary cameras may be used to capture motions of all agents 112 on the playing surface as well as one or more objects of relevance. Utilization of such a tracking system (e.g., tracking system 102) may result in multiple different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). The game file 110 may be converted from a first format (e.g., a format output by the one or more cameras or a different format than the format output by the one or more cameras) and may be converted into a second format (e.g., for broadcast transmission).

As an example, tracking data may include the positions (e.g., x=(x, y)) of each entity (or player) at each time step on a playing surface. Tracking data may be generated and/or stored in a format different than the format of a game file or broadcast transmission. For example, a broadcast transmission may include video files, whereas tracking data may be generated or stored as digital representations of agents and/or objects in a format different than the format of the broadcast transmission (e.g., different than a video file format). In some embodiments, to represent the tracking data in a well-defined structure that avoids issues presented in conventional approaches, a pre-processing agent may construct a graphical representation of the tracking data. For example, pre-processing agent may construct a graph G(V,E,U) that may be defined by nodes V, edges E, and global features U. In some embodiments, each node in a graph may represent the player and object tracking data. In some embodiments, each edge may include information about various relationships between nodes. In some embodiments, edges eij may be directed edges and connect a sending node vi to a receiving node vj.

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning model trained to receive, as an input, game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). More specifically, the determination may be made based on a component or machine learning algorithm detecting the triggering change between the first tracking data digital representation and the second tracking data digital representation, and automatically identifying correlations between the triggering change and attributes associated with one or more event types. If a correlation meets a correlation threshold for a given event type, the triggering change may be associated with the given event type, and may be tagged as event data for that event type. Such automated event data detection may be performed, for example, by a machine learning model using input data (e.g., tracking data and/or game files) that are in a non-human readable format optimized for machine learning operations. Based on such determination, for example, an event type of a goal scored may be identified based on the digital tracking data. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sporting occasions.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with a data store of organization computing system 104.

Organization computing system 104 may be configured to process the broadcast stream of the game. Organization computing system 104 may include at least a web client application server 114, a tracking data system 116, a data store 118, a play-by-play module 120, a padding module 122, and/or a multi-modal language model 124. Each of tracking data system 116, play-by-play module 120, padding module 122, and multi-modal language model 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. As described previously, the organization computing system 104 may generate a tracking data feed (e.g., tracking data, as used herein) based on a broadcast feed (e.g., broadcast data) of a sporting occasion, the tracking data feed having position information including x,y coordinates of one or more agents and x,y coordinates of one or more objects, wherein the position information of one or more agents and one or more objects from the broadcast feed is projected onto a two-dimensional playing surface including the x,y coordinates. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for multi-modal language model 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking data. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influence score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

Multi-modal language model 124 may be configured or trained to generate responses to inputted queries for a sporting occasion. Multi-modal language model 124 may incorporate a machine learning model. In some embodiments, multi-modal language model 124 may receive multiple inputs including tracking data, event data, and queries. Multi-modal language model 124 may process the inputs to generate a response, which may indicate likelihoods of events occurring during the sporting occasion. Multi-modal language model 124 may be trained using historical data to learn patterns and relationships between player movements, ball trajectories, game events, and the like.

Multi-modal language model 124 may include a spatiotemporal encoder and a transformer decoder. Spatiotemporal encoder may be configured to encode tracking data by applying spatiotemporal axial attention, which may decompose self-attention into separate temporal and spatial operations. This decomposition may reduce computational complexity from O(T²E²) to O(ET²+TE²), where T represents the number of time frames and E represents the number of entities. Transformer decoder may be configured to process queries and event data in conjunction with the encoded tracking data to generate responses. In some embodiments, multi-modal language model 124 may alternatively include a track encoder, a transformer neural network, and an event decoder. Track encoder may tokenize tracking data by partitioning the position information into time-based tracklets and matching each tracklet to entries in a codebook. Transformer neural network may apply attention mechanisms to the tokenized tracklets, queries, and event data to generate predictive outputs, which may be decoded by event decoder to produce responses.

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least an application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to input a query into multi-modal language model 124 and receive, as output from multi-modal language model 124, a response. The content that is displayed to client device 108 may be transmitted from web client application server 114 to client device 108, and subsequently processed by application 130 for display through a graphical user interface (GUI) of client device 108.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. The examples herein are illustrative only. The techniques and technologies of this disclosure may be adapted to any suitable activity.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate particular sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting occasions with corresponding time boundaries, teams, players, coaches, officials, and environmental data associated with a location of corresponding sporting occasions.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as an object, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

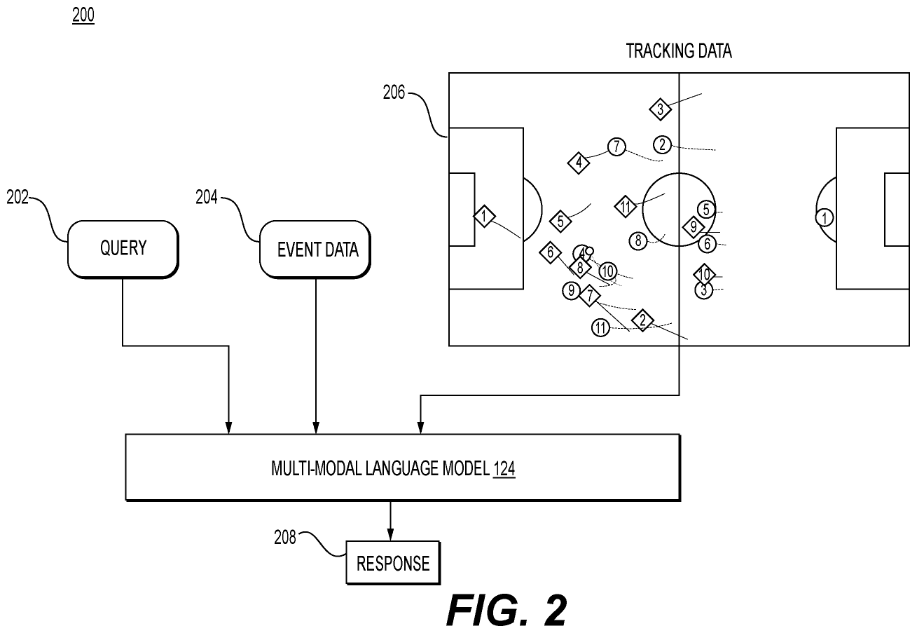

FIG. 2 depicts a block diagram of the multi-modal language model operation 200, according to example embodiments. Multi-modal language model 124, as show in FIG. 2, may receive multiple inputs and generate outputs based on the inputs. The inputs to multi-modal language model 124 may include a query 202, event data 204, and tracking data 206. Based on the tracking data feed (e.g., tracking data 206), the event data 204, and one or more tokens (as described further herein), multi-modal language model 124 may determine a response 208 to the query 202. The response 208 may be based on a likelihood of an event occurring during the sporting occasion.

Query 202 may correspond to an event in the sporting occasion. Query 202 may comprise natural language generated by a user. According to an embodiment, queries may fulfill one or more criteria when being converted into EQL prompts. Queries may be conditioned on a partial hypothetical future event sequence. Alternatively, or in addition, queries may include a query relating to the next token after this future event sequence. Questions may include hypotheticals that detail up to NF future events, and therefore this approach may be used to answer nested questions. For example, a user operating client device 108 may input query 202 via application 130, where query 202 is expressed in natural language such as “What action will player #4 complete next?” or “If player #4 passes, who is the most likely target of the pass?” Query 202 may be transmitted to organization computing system 104 via network 105 for processing by multi-modal language model 124. Query 202 may also be automatically generated by organization computing system 104 based on the current game state, tracking data 206, or event data 204. For example, organization computing system 104 may automatically generate queries to predict upcoming events, assess probabilities of various outcomes, or evaluate hypothetical scenarios.

Event data 204 may be related to events occurring during the sporting occasion. As described previously, event data 204 may be generated based on tracking data and/or content feeds. Event data 204 may include information about on-ball actions such as passes, tackles, interceptions, shots, and other events that occur during the sporting occasion.

Tracking data 206 may provide position information including x,y coordinates of one or more agents and x,y coordinates of one or more objects during the sporting occasion. As described previously, tracking data 206 may be generated by tracking data system 116 based on broadcast data received from tracking system 102. Tracking data 206 may specify two-dimensional center-of-mass locations of agents (such as players) and objects (such as a ball) throughout the sporting occasion.

Response 208 may comprise at least one of natural language, a graphic, a video, etc. For example, response 208 may include a textual description of a predicted event, a probability value indicating the likelihood of the event occurring, a visual representation of player positions and predicted movements, or a video clip highlighting the predicted action. Additional embodiments of response are discussed herein. In some embodiments, query 202 and response 208 may be displayed in a virtual chat environment, where the user may interact with multi-modal language model 124 through a conversational interface. Response 208 may include a description of the event and a description of a second event. For example, response 208 may describe that player #4 will most likely complete a pass to player #9, and may further describe that if the pass is successful, player #9 has a certain probability of scoring with their next action.

Multi-modal language model 124 may receive more than one query corresponding to an event for analysis. For example, multi-modal language model 124 may receive a second query corresponding to the event. Based on the event data 204 and tracking data 206, multi-modal language model 124 may determine a second response to the query. The second response may be based on the likelihood of the event occurring and a feature related to the event, the feature being one of a player, a team, a target, and an outcome. For example, if the first query asks “What action will player #4 complete next?” and the response indicates a pass, the second query may ask “Who is the most likely target of the pass?” and the second response may identify a specific player as the target. In a further example, multi-modal language model 124 may receive a second query corresponding to the event, and so on.

In some embodiments, organization computing system 104 may receive real-time or near real-time bids for a predicted occurrence of either the event or the second event. Organization computing system 104 may identify a winning user of a plurality of users based on the real-time or near real-time bids. For example, users may place bids on whether player #4 will pass to player #9, and organization computing system 104 may determine a winning user based on the actual outcome of the event.

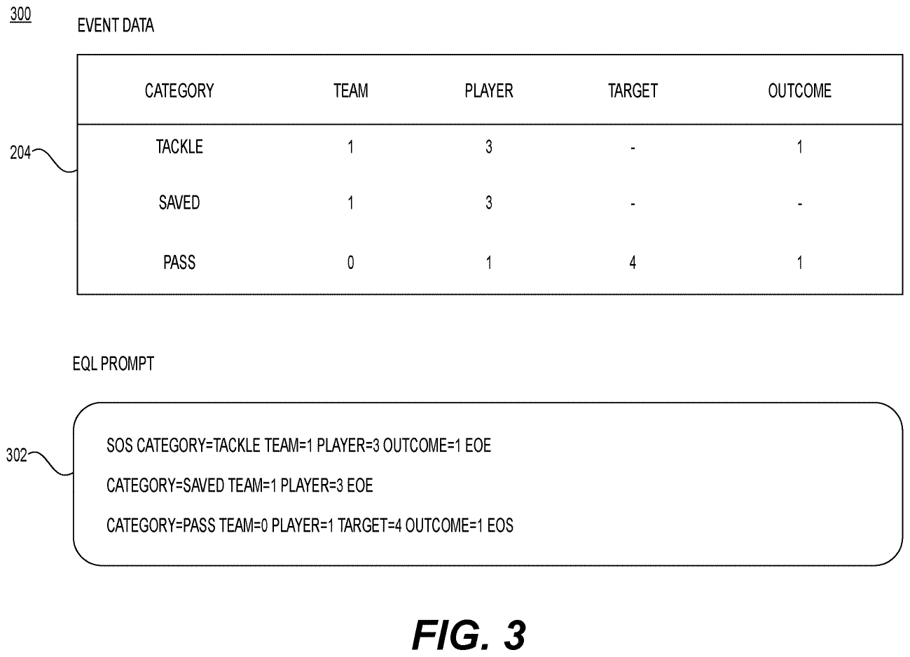

FIG. 3 depicts a graph 300 of event data as converted to an EQL prompt, according to example embodiments. As described previously, event data 204 may be related to events occurring during the sporting occasion. Organization computing system 104 may translate the query 202 into one or more tokens. Organization computing system 104 may also translate the event data 204 into one or more tokens. Tokens translated from the query 202 may be referred to as “query tokens,” or, more generally, “tokens” hereinafter. Tokens translated from the event data 204 may be referred to as “event tokens” or, more generally, “tokens” hereinafter. The one or more tokens may form an EQL prompt 302, which may provide a standardized structure for expressing queries and event data as sequences of discrete language tokens.

EQL may comprise a tokenized language with discrete language tokens representing event attributes. The EQL vocabulary may contain, for example, 47 tokens. The 47 tokens may comprise 16 category tokens, 2 team tokens, 12 player tokens, 12 target tokens, 2 outcome tokens, and 3 special tokens. The special tokens may include a start of sequence (SOS) token, an end of sequence (EOS) token, and an end of event (EOE) token. The number of tokens may be different depending on the type of sporting occasion, special rules related to the sporting occasion, etc. Query 202 (when tokenized) may comprise query tokens representing at least one of an event identifier, a team identifier, a player identifier, a target identifier, and an outcome identifier. The event data 204 (when tokenized) may comprise event tokens representing at least one of an event identifier, a team identifier, a player identifier, a target identifier, and an outcome identifier.

The event identifier may be related to an action in the sporting occasion. In soccer, for example, the event categories may include 16 on-ball event types. The events may be one of a pass, ball recovery, out-of-bounds, ball touch, tackle, take on, clearance, free kick, aerial duel, claim, interception, shot saved, blocked pass, shot off target, goal, and shot post. For example, the pass event may be defined as the attempted delivery of the ball from one player to another player on the same team. The ball recovery event may be defined as when a player gathers a loose ball and gains control of possession for their team. The out-of-bounds event may indicate the ball has gone out of play for a throw-in or goal kick. The tackle event may be defined when a player connects with the ball in a legal, ground level challenge and successfully takes the ball away from the opposition player. The goal event may attribute a goal to the goal scoring player.

The team identifier may be related to a team in the sporting occasion. The team attribute may specify if a player is part of the away team. Being a binary variable, the team attribute may have two values: team=0 and team=1. The player identifier may be related to an agent in the sporting occasion. In soccer, for example, the player attribute may have 12 possible options corresponding to 12 roles defined within each unique formation. The 12 roles may be represented by integers from 0-11 for on-field players, and 99 for a substituted player. The target identifier may be related to a second agent in the sporting occasion intended to receive a pass from a first agent in the sporting occasion. Similar to the player attribute, the target attribute may uniquely identify a single player and may have the same options, for example: target=0 through target=11, and target=99.

The outcome identifier may be related to whether the event was completed. The outcome attribute may specify if an event is successful or unsuccessful. The outcome attribute may have two options: outcome=0 and outcome=1. The pass event may include an outcome attribute where outcome=0 indicates an unsuccessful pass that did not find a teammate and outcome=1 indicates a successful pass. The tackle event may include an outcome attribute where outcome=1 indicates the tackling player's team gains possession or the ball goes out of play and outcome=0 indicates possession remains with the opponent. The ball touch event may include an outcome attribute where outcome=1 indicates the ball simply hit the player unintentionally and outcome=0 indicates the player unsuccessfully controlled the ball.

Each attribute in a given event may be represented using a single discrete language token. Each token may be constructed by joining the attribute's name with its value, separated by an equals sign. For example, if an event's category is a pass, the category token may be written as: category=pass. Each event's attribute tokens may be concatenated, where attributes may be arranged in a specific order. A first set of tokens of the one or more tokens may include, in order, the SOS token, a token representing an event identifier, a token representing a team identifier, a token representing a player identifier, a token representing a target identifier, a token representing an outcome identifier, and the EOS token. For events where certain attributes are not applicable, the corresponding tokens may be dropped. When multiple events are tokenized, events may be separated using the EOE token.

As described previously, organization computing system 104 may translate the query 202 into one or more tokens. Organization computing system 104 may convert the query 202 from natural language into the Event Query Language (EQL) by parsing the query to identify relevant event attributes such as event categories, team identifiers, player identifiers, target identifiers, and outcome identifiers. For example, if a user submits a natural language query such as “What action will player #4 complete next?”, organization computing system 104 may analyze the query to extract the category identifier, team identifier, player identifier, target identifier and/or outcome identifier. Organization computing system 104 may then generate corresponding EQL tokens that represent these extracted attributes. The conversion process may involve mapping natural language terms to their corresponding discrete language tokens in the EQL vocabulary, which may contain tokens for event categories (e.g., pass, tackle, shot), team designations, player roles, target designations, and outcome values.

Organization computing system 104 may also translate the event data 204 into one or more tokens. Organization computing system 104 may convert the event data 204 into the Event Query Language (EQL) by parsing the event data to identify relevant event attributes such as event categories, team identifiers, player identifiers, target identifiers, and outcome identifiers. For example, if event data 204 indicates that a player completed a pass to a teammate, organization computing system 104 may analyze the event data to extract the category identifier, team identifier, player identifier, target identifier and/or outcome identifier. Organization computing system 104 may then generate corresponding EQL tokens that represent these extracted attributes. The conversion process may involve mapping event attributes to their corresponding discrete language tokens in the EQL vocabulary, which may contain tokens for event categories (e.g., pass, tackle, shot), team designations, player roles, target designations, and outcome values.

While the examples described herein reference soccer as the sporting occasion, it is appreciated that the systems and methods disclosed may be applied to other sports including basketball, American football, cricket, hockey, volleyball, and other team-based sporting occasions. For basketball, for example, the event categories may include on-ball event types such as a shot, pass, dribble, turnover, rebound, steal, block, foul, and free throw. The player identifier in basketball may have options corresponding to the five on-court positions for each team. The target identifier may identify the intended recipient of a pass or the player being defended. The outcome identifier may specify whether a shot was made or missed, whether a pass was completed or intercepted, or whether a rebound was secured by the offensive or defensive team. The tracking data for basketball may specify two-dimensional center-of-mass locations of players and the ball projected onto the court surface, enabling the multi-modal language model to process queries and generate responses regarding predicted events in basketball sporting occasions.

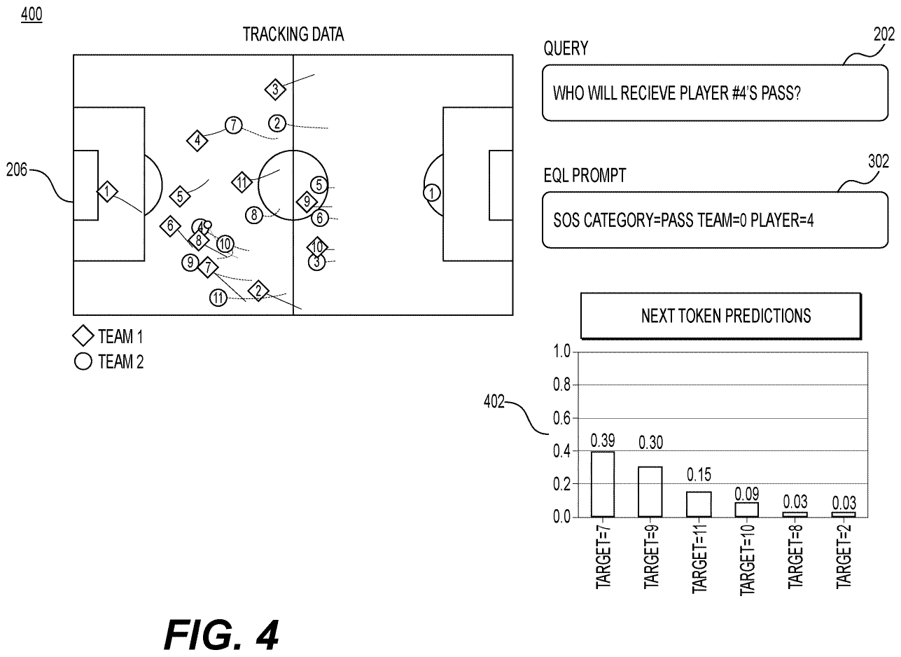

FIG. 4 depicts charts 400 of example inputs and outputs of the multi-modal language model, according to example embodiments. Charts 400 illustrates how multi-modal language model 124 processes tracking data 206, the query 202, and EQL prompt 302 to generate next token predictions 402. Next token predictions 402 may represent the predicted likelihoods of various tokens occurring next in the EQL sequence. As described previously, the response 208 may be based on a likelihood of the event occurring. Multi-modal language model 124 may output one or more likelihoods of possible events occurring, wherein the possible events are related to the sporting occasion.

Multi-modal language model 124 may be tasked with predicting the intended receiver of a hypothetical pass. Multi-modal language model 124 may generate next token predictions 402 that indicate the probability of each player receiving the pass. The predictions generated by multi-modal language model 124 may appear logical, where players who are close to and/or in front of the player with the ball may be shown to have higher likelihoods of receiving the pass. For example, if player #4 has possession of the ball, multi-modal language model 124 may predict that player #7, who is positioned closer to player #11 and in a favorable receiving position, has a higher probability of being the target of the pass compared to players who are farther away or positioned behind the ball carrier.

Multi-modal language model 124 may determine a likelihood of a first event occurring and a likelihood of a second event occurring based on interactions between the one or more agents and the one or more objects identified from tracking data 206. Multi-modal language model 124 may compare the likelihood of the first event occurring and the likelihood of the second event occurring. Based on the comparing, multi-modal language model 124 may identify that the first event is more likely occurring than the second event. For example, multi-modal language model 124 may determine that a pass to player #7 has a 39% probability of succeeding, while a pass to player #11 has a 15% probability of succeeding. By comparing these likelihoods, multi-modal language model 124 may identify that the pass to player #7 is more likely to succeed than the pass to player #11.

Multi-modal language model 124 may receive second queries, third queries, etc. corresponding to an event related to the first query and generate corresponding responses. A second response may be based on the likelihood of the event occurring and a feature related to the event, the feature being one of a player, a team, a target, and an outcome. For example, if the first query asks “What action will player #4 complete next?” and the response indicates a pass, a second query may ask “Who is the most likely target of the pass?” and the second response may identify player #7 as the target based on the predicted likelihoods. A third response may be based on the likelihood of the event occurring and a second feature related to the event, the feature being one of a player, a team, a target, and an outcome. For example, a third query may ask “Is the pass from #4 to #7 likely to be successful?” and the third response may indicate a 39% probability of success based on the outcome feature.

In contrast to multi-modal language model 124, baseline transformer models that do not utilize tracking data 206 may predict all players to have approximately the same probability of receiving a pass. In some embodiments, both multi-modal language model 124 and a baseline transformer model may be tasked with predicting the intended receiver of a hypothetical pass, and a visualization may display the top-6 token predictions from each model. Multi-modal language model 124's predictions may appear logical, where players who are close to and/or in front of the player with the ball may be shown to have higher likelihoods of receiving the pass. In contrast, the baseline transformer model may predict all players to have approximately the same probability of receiving the pass, such as approximately 9% each for the 11 players on the receiving team. Baseline transformer models may lack access to fine-grained spatiotemporal context and therefore may not distinguish between different players based on their trajectories on the field. This example may highlight the importance of utilizing fine-grained spatiotemporal context when predicting future behaviors in sports analytics applications.

By conditioning on tracking data 206, multi-modal language model 124 may reason about player positions, movements, and spatial relationships to generate more accurate predictions. Based on the identifying that the first event is more likely occurring than the second event, organization computing system 104 may adjust weights of a machine learning model that determines the likelihood of events occurring. For example, during training, if multi-modal language model 124 incorrectly predicts that a pass to player #11 is more likely than a pass to player #7, and the actual outcome shows that player #7 received the pass, the weights of multi-modal language model 124 may be adjusted to improve future predictions based on similar tracking data patterns. Training multi-modal language mode 124 is discussed in greater detail herein.

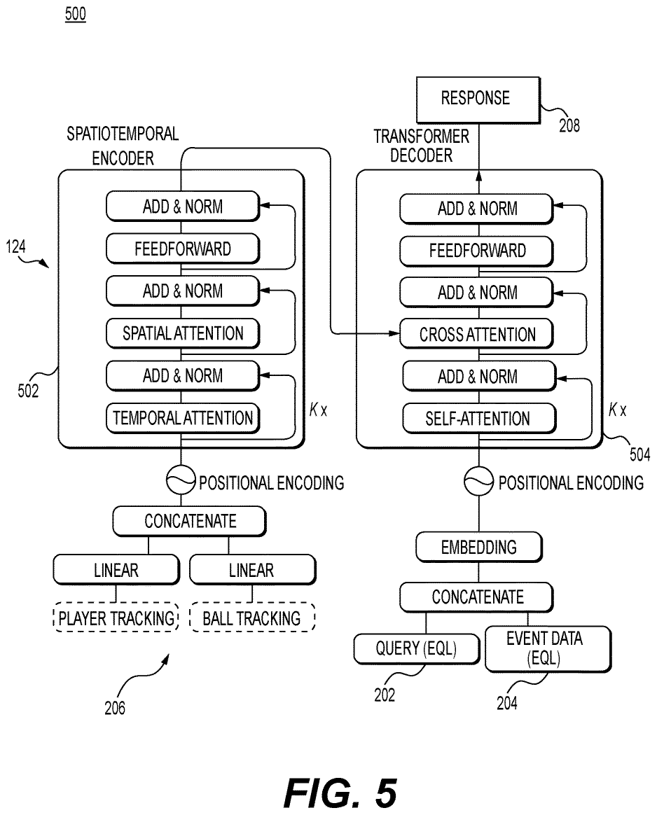

FIG. 5 depicts a first embodiment of multi-modal language model architecture 500, according to example embodiments. The first embodiment of multi-modal language model architecture 500 may include a spatiotemporal encoder 502 and a transformer decoder 504. Spatiotemporal encoder 502 may be configured to receive and process tracking data 206 to generate encoded representations of the spatiotemporal context of the sporting occasion. Transformer decoder 504 may be configured to receive EQL representations of the query 202 (e.g., query tokens), EQL representations of the event data 204 (e.g., event tokens), and the encoded representations from spatiotemporal encoder 502 to generate the response 208.

Spatiotemporal encoder 502 may receive tracking data 206 as input. As described previously, tracking data 206 may provide position information including x,y coordinates of one or more agents (or player, used interchangeably herein) and x,y coordinates of one or more objects during the sporting occasion. Each frame of tracking data 206 may provide the locations of Eₚ players and E_{b}=1 ball. In soccer, for example, there may be Eₚ=22 players (11 on both teams). However, this value may decrease when player(s) are sent off or are off the pitch due to an injury.

Tracking data 206 may include a player input tensor and a ball input tensor. The player input tensor may have a shape T×Eₚ× Dₚ, where T represents the number of time frames, Eₚ represents the number of players, and Dₚ represents the number of features for each player tracking observation. Dₚ may equal 42 features for each player tracking observation. The 42 features may include the (x,y) coordinate of the player, team affiliation, and one-hot encodings of player roles and team formations. The one-hot encodings may enable spatiotemporal encoder 502 to distinguish between different players based on their roles within the team's formation.

The ball input tensor may have a shape T×E_{b}×D_{b}, where T represents the number of time frames, E_{b}=1 represents the single ball entity, and D_{b} represents the number of features for the ball tracking observation. D_{b} may equal 2 features specifying the (x,y) location of the ball. The ball input tensor may provide the position of the ball at each time frame throughout the tracking data segment.

The tracking data streams may be downsampled to 5 Hz from their native 25 Hz for processing by multi-modal language model 124. Games may be split into 3 second segments, meaning that T=15 frames may be used as tracking context for multi-modal language model 124. The 3 second segments at 5 Hz may provide sufficient temporal context for spatiotemporal encoder 502 to capture player movements and interactions while maintaining computational efficiency.

In some embodiments, portions of games where play was stopped may be discarded during preprocessing to focus the training and analysis on active gameplay segments. The discarding process may involve analyzing event data 204 to identify timestamps corresponding to stoppages such as out-of-bounds events, fouls, or substitutions, and removing tracking data frames that fall within temporal windows surrounding these stoppage events. Organization computing system 104 may apply filtering logic that detects periods where ball movement velocity falls below a predetermined threshold for a specified duration, indicating inactive play, and may exclude these segments from the training dataset to ensure that multi-modal language model 124 is trained on continuous, active gameplay sequences.

With continued reference to FIG. 5, organization computing system 104 or spatiotemporal encoder 502 may linearize the position information including the x,y coordinates of one or more agents and the x,y coordinates of one or more objects. Linearizing the position information may involve flattening or reshaping the multi-dimensional tracking data into a format suitable for processing by attention mechanisms. The player input tensor and the ball input tensor may have different feature dimensions (Dₚ=42 for players and D_{b}=2 for the ball). To allow these inputs to be jointly processed by a single attention operation, both tensors may be independently projected into a shared feature space of dimensionality Dₕ using separate linear projections.

Organization computing system 104 or spatiotemporal encoder 502 may concatenate the position information. After the linear projections, the resulting tensors may be concatenated along the entity dimension, producing a tensor of shape T×E×Dₕ, where E=Eₚ+E_{b} represents the total number of entities (players plus ball). The concatenation may combine the player and ball representations into a unified tensor that spatiotemporal encoder 502 may process using attention mechanisms.

Organization computing system 104 or spatiotemporal encoder 502 may encode the position information. The encoding process may involve applying sinusoidal positional encodings along the temporal axis of the tracking data to specify the sequential ordering of each frame of tracking input. As transformers may be naturally permutation equivariant, the positional encodings may add the values of sine and cosine functions to inputs based on their index in the sequence, enabling spatiotemporal encoder 502 to perceive the temporal ordering of the tracking data frames.

Transformer decoder 504 may receive EQL representations of the query 202 (e.g., query tokens) and EQL representations of the event data (e.g., event tokens) as input. Transformer decoder 504 may incorporate the tracking context by cross-attending to the output of spatiotemporal encoder 502. The cross-attention mechanism may allow transformer decoder 504 to selectively attend to relevant portions of the encoded tracking data when generating predictions. Transformer decoder 504 may use a causal attention mask to ensure the model cannot “look ahead” beyond the current token when predicting the next token in the EQL sequence. After stacking the decoder layer K times, each token may be projected to a tensor of length 47 (corresponding to the EQL vocabulary size) by a learned linear projection. Each of these tokens may be passed through a softmax activation to generate probability distributions over the next token. The output of transformer decoder 504 may be a sequence of tokens, where each output element specifies the estimated probability distribution of the next token in the sequence, which may be used to generate the response 208.

The encoder and decoder architectures may both have hidden dimensionalities of Dₕ=128. The encoder and decoder architectures may include feedforward layers of dimensionality 512. The encoder and decoder architectures may include 4 attention heads. The encoder and decoder architectures may include K=4 stacked Transformer layers. The stacked Transformer layers may enable spatiotemporal encoder 502 to learn deep latent representations of the tracking input by repeatedly applying attention and feedforward operations.

Spatiotemporal encoder 502 may process the position information via spatiotemporal axial attention. Spatiotemporal axial attention may decompose self-attention into two separate operations: temporal attention and spatial attention. Temporal attention may operate on each agent independently to encode agent-specific motion. Spatial attention may perform attention within each timestep independently to model inter-agent dependencies. By decomposing self-attention into these two operations, spatiotemporal axial attention may identify how the one or more agents and how the one or more objects move over time and how the one or more agents and how the one or more objects interact.

Temporal attention may allow spatiotemporal encoder 502 to identify how individual agents move throughout the tracking data segment. For each agent (whether a player or the ball), temporal attention may compute attention scores between different time frames for that agent. Temporal attention may enable spatiotemporal encoder 502 to capture motion patterns such as acceleration, deceleration, changes in direction, and other movement characteristics specific to each agent. By operating on each agent independently, temporal attention may encode the trajectory of each player and the ball without interference from other entities.

Spatial attention may allow spatiotemporal encoder 502 to identify how agents interact with each other at each moment in time. For each timestep in the tracking data, spatial attention may compute attention scores between different entities present at that timestep. Spatial attention may enable spatiotemporal encoder 502 to capture relationships such as proximity between players, defensive coverage patterns, passing lanes, and other spatial configurations. By performing attention within each timestep independently, spatial attention may model the inter-agent dependencies that exist at each frame of the sporting occasion.

Both temporal attention and spatial attention may be expressed in terms of masked self-attention. The attention operation may be defined as Attention(Q,K,V)=softmax(A/√Dₕ) V, where Q, K, and V represent the query, key, and value matrices used for attention, and Dₕ represents the hidden dimensionality. The attention matrix A may be computed as A=M⊙ (QK^{T}), where M represents an attention mask and ⊙ represents the Hadamard product (element-wise multiplication). The Hadamard product may be used to zero specific attention weights according to the attention mask, preventing attention between tokens that are not expected to attend to each other.

The temporal mask M^{temporal} may prevent attention between tokens that belong to different entities. For temporal attention, the mask may allow attention between tokens only if the tokens correspond to the same entity (the same player or the ball) at different timesteps. The temporal mask may be formulated such that M^{temporal}_{i,j} equals 1 if the floor division of index i by the number of entities E equals the floor division of index j by E, and equals negative infinity otherwise. When the mask value is negative infinity, the softmax operation may produce an attention weight of approximately zero, effectively preventing attention between those tokens.

The spatial mask M^{spatial} may allow attention only if tokens exist at the same timestamp. For spatial attention, the mask may allow attention between tokens only if the tokens correspond to the same timestep but different entities. The spatial mask may be formulated such that M^{spatial}_{i,j} equals 1 if index i modulo T equals index j modulo T (where T represents the number of timesteps), and equals negative infinity otherwise. The spatial mask may enable spatiotemporal encoder 502 to compute attention between all players and the ball at each individual frame of tracking data.

Spatiotemporal axial attention may provide computational advantages compared to standard self-attention. When applied across the tracking input, standard self-attention may have O(T²E²) memory and runtime complexity, where T represents the number of time frames and E represents the number of entities. In contrast, temporal attention may have O(ET²) complexity because temporal attention computes attention across T timesteps for each of E entities independently. Spatial attention may have O(TE²) complexity because spatial attention computes attention across E entities for each of T timesteps independently. Collectively, spatiotemporal axial attention may have computational complexity of O(ET²+TE²), which may provide better asymptotic complexity compared to standard self-attention with O(T²E²) complexity. The reduced computational complexity may enable spatiotemporal encoder 502 to process longer sequences of tracking data or larger numbers of entities while maintaining computational efficiency.

Spatiotemporal encoder 502 may output encoded data based on the position information. The encoded data may represent a deep latent representation of the tracking input that captures both the temporal dynamics of individual agent movements and the spatial relationships between agents at each timestep. The encoded data may be provided to transformer decoder 504 for cross-attention when generating predictions in response to queries.

Transformer decoder 504 may receive the one or more query tokens related to the query 202 and one or more event tokens related to the event data 204 as input (collectively, one or more tokens). Organization computing system 104 or transformer decoder 504 may concatenate the one or more tokens to form a combined input sequence. The concatenation may arrange the query tokens and event tokens in a sequential order that transformer decoder 504 may process to generate predictions. For example, the combined input sequence may include the SOS token, followed by event tokens representing previous events, followed by query tokens representing the query being answered.

Organization computing system 104 or transformer decoder 504 may embed the one or more tokens. The embedding process may replace each discrete language token with a token-specific learned embedding vector. The learned embedding vectors may map each of the 47 tokens in the EQL vocabulary to a continuous vector representation of dimensionality Dₕ. The embedding vectors may be learned during training such that tokens with similar semantic meanings may have similar vector representations.

Organization computing system 104 or transformer decoder 504 may encode the one or more tokens. The encoding process may involve adding sinusoidal positional embeddings to the embedded tokens. The sinusoidal positional embeddings may specify the sequential position of each token within the input sequence, enabling transformer decoder 504 to perceive the ordering of tokens. The positional embeddings may add values of sine and cosine functions to the embedded tokens based on their index in the sequence.

Transformer decoder 504 may use a causal attention mask to ensure the model 124 cannot look ahead beyond the current token. The causal attention mask may prevent each token from attending to tokens that appear later in the sequence. When predicting the next token at position i, transformer decoder 504 may attend to tokens at positions 1 through i−1 but may not attend to tokens at positions i+1 and beyond. The causal attention mask may be implemented by setting attention weights to negative infinity for positions that should not be attended to, causing the softmax operation to produce attention weights of approximately zero for those positions. The causal masking may enable transformer decoder 504 to be trained using teacher forcing while maintaining the autoregressive property during inference.

Transformer decoder 504 may incorporate tracking context by cross-attending to the output of spatiotemporal encoder 502. The cross-attention mechanism may allow transformer decoder 504 to selectively attend to relevant portions of the encoded tracking data when generating each token prediction. During cross-attention, transformer decoder 504 may use the token representations as queries and the encoded tracking data as keys and values. The cross-attention operation may compute attention scores between each token position and each position in the encoded tracking data, enabling transformer decoder 504 to incorporate spatial and temporal context from the tracking data into the token predictions. The cross-attention mechanism may allow transformer decoder 504 to reason about player positions, movements, and interactions when predicting the next token in the EQL sequence.

Transformer decoder 504 may process the one or more tokens and the encoded data through multiple stacked transformer layers. Each transformer layer may include a self-attention sublayer with causal masking, a cross-attention sublayer that attends to the encoded tracking data, and a feedforward sublayer. The self-attention sublayer may allow tokens to attend to previous tokens in the sequence. The cross-attention sublayer may allow tokens to attend to the encoded tracking data from spatiotemporal encoder 502. The feedforward sublayer may apply non-linear transformations to the token representations. Each sublayer may include residual connections and layer normalization to facilitate training of deep networks.

Transformer decoder 504 may project each token to a tensor of length 47 by a learned linear projection. The linear projection may map the hidden representation of each token from dimensionality Dₕ to a tensor of length 47, where 47 corresponds to the number of tokens in the EQL vocabulary. The learned linear projection may be trained to produce logits that indicate the relative likelihood of each vocabulary token being the next token in the sequence.

Each token may be passed through a softmax activation to output the estimated probability distribution of the next token. The softmax activation may convert the logits from the linear projection into a probability distribution that sums to one. The probability distribution may indicate the likelihood of each of the 47 vocabulary tokens being the next token in the EQL sequence. The token with the highest probability may be selected as the predicted next token, or the probability values may be used directly to answer queries about event likelihoods.

Transformer decoder 504 may output one or more likelihoods of possible events occurring, wherein the possible events are related to the sporting occasion. The output probability distributions may indicate the likelihood of various event categories, teams, players, targets, and outcomes occurring. For example, when predicting the target of a pass, transformer decoder 504 may output a probability distribution over the 12 possible target tokens, where each probability value indicates the likelihood of that player being the intended recipient of the pass.

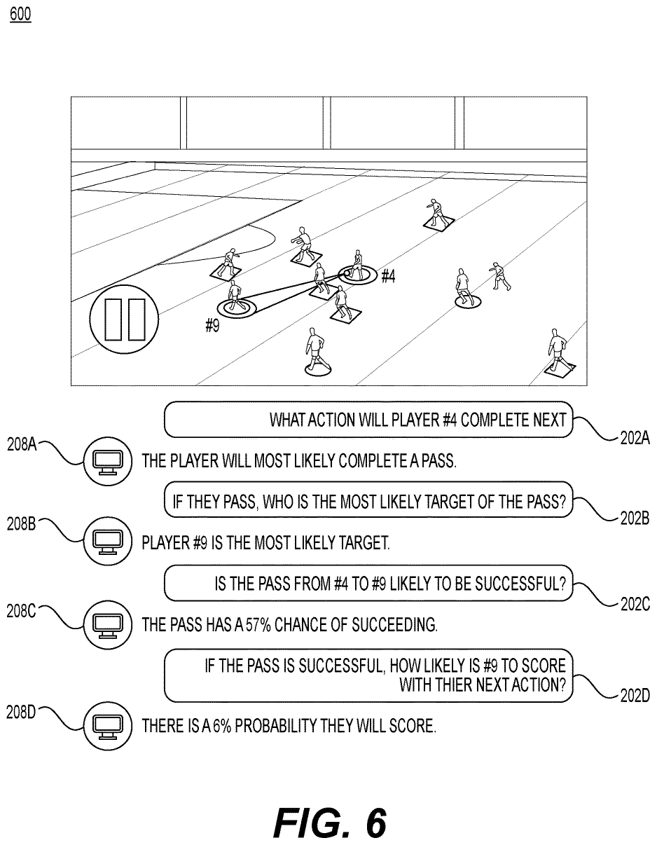

FIG. 6 depicts a first block diagram 600 of a sporting event and the multi-modal language model output, according to example embodiments. First block diagram 600 illustrates how multi-modal language model 124 may handle multiple queries corresponding to events in a sporting occasion and generate corresponding responses. First block diagram 600 includes a first query 202A, a second query 202B, a third query 202C, a fourth query 202D, a first response 208A, a second response 208B, a third response 208C, and a fourth response 208D.

First query 202A may correspond to an event in the sporting occasion. For example, first query 202A may ask “What action will player #4 complete next?” Organization computing system 104 may receive first query 202A and translate first query 202A into one or more tokens. Based on the tracking data feed, the one or more query tokens, and the one or more event tokens, organization computing system 104 may determine first response 208A to first query 202A. First response 208A may indicate that the player will most likely complete a pass. First response 208A may be based on a likelihood of the event occurring, where multi-modal language model 124 predicts the most probable event category based on the current game state represented in the tracking data.

Organization computing system 104 may receive a second query corresponding to the event. Second query 202B may correspond to the same event addressed by first query 202A. For example, second query 202B may ask “If they pass, who is the most likely target of the pass?” Organization computing system 104 may translate second query 202B into one or more tokens. Based on the tracking data feed, the one or more query tokens, and the one or more event tokens, organization computing system 104 may determine second response 208B to second query 202B. Second response 208B may be based on the likelihood of the event occurring and a feature related to the event, the feature being one of a player, a team, a target, and an outcome. In the example of second query 202B, the feature may be a target, and second response 208B may identify player #9 as the most likely target of the pass.

Organization computing system 104 may receive a third query corresponding to the event. Third query 202C may correspond to the same event addressed by first query 202A and second query 202B. For example, third query 202C may ask “Is the pass from #4 to #9 likely to be successful?” Organization computing system 104 may translate third query 202C into one or more tokens. Based on the tracking data feed, the one or more query tokens, and the one or more event tokens, organization computing system 104 may determine third response 208C to third query 202C. Third response 208C may be based on the likelihood of the event occurring and a second feature related to the event, the feature being one of a player, a team, a target, and an outcome. In the example of third query 202C, the second feature may be an outcome, and third response 208C may indicate a probability (e.g., 57%) that the pass will succeed.

Organization computing system 104 may receive a fourth query corresponding to the event. Fourth query 202D may correspond to the same event addressed by first query 202A, second query 202B, and third query 202C. For example, fourth query 202D may ask “If the pass is successful, how likely is #9 to score with their next action?” Organization computing system 104 may translate fourth query 202D into one or more tokens by prepending additional hypothetical events to the EQL prompt. The EQL prompt for fourth query 202D may include tokens representing the hypothetical successful pass from player #4 to player #9, followed by tokens querying the likelihood of player #9 scoring. Based on the tracking data feed, the one or more query tokens, and the one or more event tokens, organization computing system 104 may determine fourth response 208D. Fourth response 208D may indicate a probability (e.g., 6%) that player #9 will score with their next action following the successful pass.

This nested question capability of multi-modal language model 124 may enable analysis of the longer-term impacts of player actions. Questions may condition on partial hypothetical future event sequences and include a query relating to the next token after the hypothetical sequence. Questions may include hypotheticals that detail up to NF future events, where F may equal the number of future events. By prepending additional hypothetical events to the beginning of EQL prompts, multi-modal language model 124 may answer questions that extend past the next immediate event.

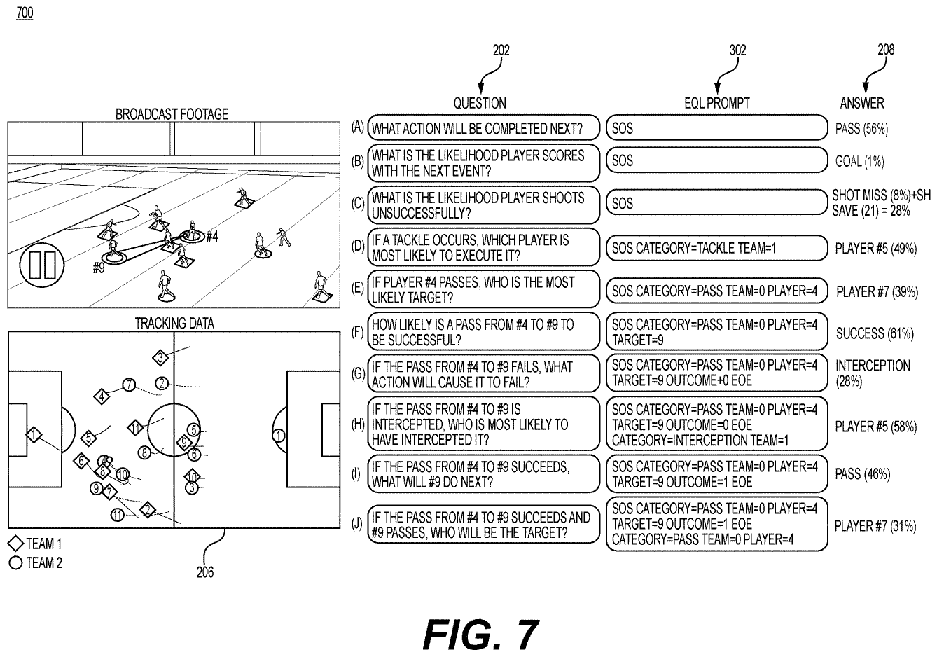

FIG. 7 depicts a second block diagram 700 of a sporting event and the multi-modal language model output, according to example embodiments. Second block diagram 700 illustrates multiple queries 202 and responses 208 thereto.

Specifically, as shown in FIG. 7, a first query may ask “What action will be completed next?” This query may be translated into an EQL prompt including an SOS token. Based on inputs discussed above, multi-modal language model 124 may output a first response indicating that there is a 56% chance that the next action will be a pass.

A second query may ask “What is the likelihood player scores with the next event?” This query may be translated into an EQL prompt including an SOS token. Based on inputs discussed above, multi-modal language model 124 may output a second response indicating that there is a 1% chance that a player scores with the next event.

A third query may ask “What is the likelihood player scores with the next event?” This query may be translated into an EQL prompt including an SOS token. Based on inputs discussed above, multi-modal language model 124 may output a third response indicating that there is a 28% chance that a player shoots unsuccessfully.

A fourth query may ask “If a tackle occurs, which player is most likely to execute it?” This query may be translated into an EQL prompt including an SOS token, a category token (category=tackle), and a team token (team=1). Based on inputs discussed above, multi-modal language model 124 may output a fourth response indicating that player #5 is most likely to execute a tackle (by 49%).

A fifth query may ask “If player #4 passes, who is the most likely target?” This query may be translated into an EQL prompt including an SOS token, a category token (category=pass), a team token (team=0), and a player token (player=4). Based on inputs discussed above, multi-modal language model 124 may output a fifth response indicating that player #7 is the most likely target (by 39%).

A sixth query may ask “How likely is a pass from #4 to #9 to be successful?” This query may be translated into an EQL prompt including an SOS token, a category token (category=pass), a team token (team=0), a player token (player=4), and a target token (target=9). Based on inputs discussed above, multi-modal language model 124 may output a sixth response indicating a 61% success chance.

A seventh query may ask “If the pass from #4 to #9 fails, what action will cause it to fail?” This query may be translated into an EQL prompt including an SOS token, a category token (category=pass), a team token (team=0), a player token (player=4), a target token (target=9), an outcome token (outcome=0), and an EOE token. Based on inputs discussed above, multi-modal language model 124 may output a seventh response indicating an interception is the most likely action (by 28%).

A eighth query may ask “If the pass from #4 to #9 is intercepted, who is most likely to have intercepted it?” This query may be translated into an EQL prompt including an SOS token, a category token (category=pass), a team token (team=0), a player token (player=4), a target token (target=9), an outcome token (outcome=0), an EOE token, a second category token (category=interception), and a second team token (team=1). Based on inputs discussed above, multi-modal language model 124 may output an eighth response indicating that player #5 is most likely to intercept the pass (by 58%).

A ninth query may ask “If the pass from #4 to #9 succeeds, what will #9 do next?” This query may be translated into an EQL prompt including an SOS token, a category token (category=pass), a team token (team=0), a player token (player=4), a target token (target=9), an outcome token (outcome=1), and an EOE token. Based on inputs discussed above, multi-modal language model 124 may output an ninth response indicating that player #9 will most likely pass the ball (by 46%).

A tenth query may ask “If the pass from #4 to #9 succeeds and #9 passes, who will be the target?” This query may be translated into an EQL prompt including an SOS token, a category token (category=pass), a team token (team=0), a player token (player=4), a target token (target=9), an outcome token (outcome=1), an EOE token, a second category token (category=pass), a second team token (team=0), and a second player token (player=4). Based on inputs discussed above, multi-modal language model 124 may output a tenth response indicating that player #7 is the most likely target (by 31%).

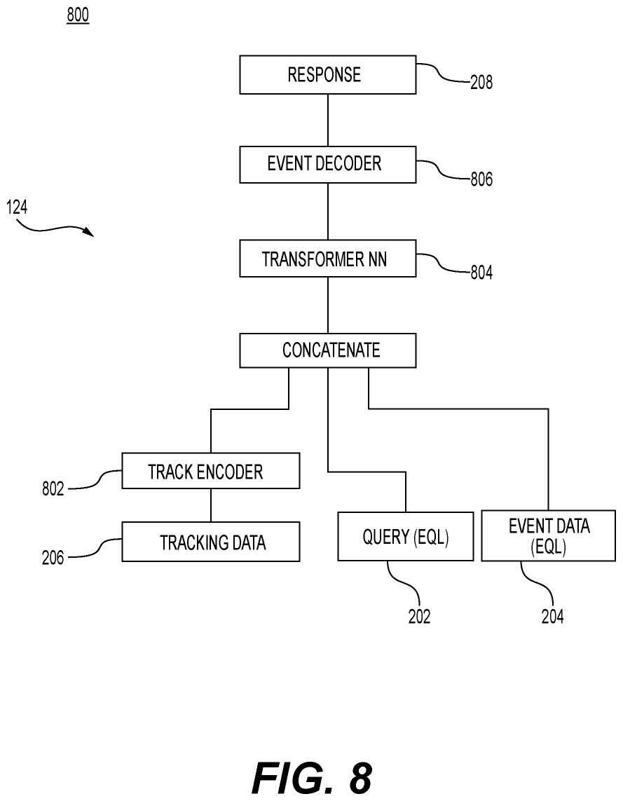

FIG. 8 depicts a second embodiment of multi-modal language model architecture 800, according to example embodiments. The second embodiment of multi-modal language model architecture 800 may include a track encoder 802, a transformer neural network 804, and an event decoder 806. Track encoder 802 may be configured to receive and process tracking data 206 to generate tokenized representations of player and object movements. Transformer neural network 804 may be configured to process the tokenized representations along with EQL representations of the query 202 (e.g., query tokens) and EQL representations of the event data 204 (e.g., event tokens) to generate predictive outputs. Event decoder 806 may be configured to decode the predictive outputs to produce the response 208.

Track encoder 802 may partition the tracking data 206 into time-based tracklets. Each tracklet of the time-based tracklets may represent movement patterns over a predetermined time interval. The predetermined time interval for each tracklet may be one second. By partitioning the continuous tracking data into discrete one-second segments, track encoder 802 may capture movement patterns that occur within each time interval while reducing the dimensionality of the input data.

Track encoder 802 may tokenize the tracklets by matching each tracklet to entries in a codebook to generate numeric identifiers representing the movement patterns. The codebook may contain a plurality of movement shapes, where each of the plurality of movement shapes may be associated with a unique numeric identifier. The codebook may contain thousands of entries, where the total number of entries may be determined based on computational constraints, memory limitations, or performance requirements. For example, the codebook may be configured to contain a specific number of entries such as 1,000, 5,000, or 10,000 tracklet shapes to balance between representation accuracy and computational efficiency. The tokenization process may reduce the token count from approximately 3.5 million player locations, 150,000 ball locations, and 2,000 events to, for example, approximately 130,000 to 160,000 tokens per sporting occasion. For example, the tokenization process may reduce the token count by approximately 80-95%. This reduction in token count may enable transformer neural network 804 to process complete matches while maintaining computational efficiency.

Transformer neural network 804 may receive the tokenized tracklets from track encoder 802 along with the query tokens and the event data tokens. Transformer neural network 804 may concatenate the tokenized tracklets, the query tokens, and the event data tokens to form a combined input sequence. Transformer neural network 804 may apply an attention mechanism to the tokenized tracklets, the query tokens, and the event tokens to generate predictive outputs. The attention mechanism may selectively apply attention weights between the tokenized tracklets, the query tokens, and the event tokens based on temporal proximity and entity relationships.

The embeddings processed by transformer neural network 804, including the tokenized tracklets, the query tokens, and the event tokens, may be arranged in an embedding chart that comprises a two-dimensional grid structure. In the embedding chart, columns may represent timestamps during the sporting occasion and rows may represent different entities, such as events, individual players, and the ball or other objects. This columnar arrangement may maintain temporal alignment between different types of data, ensuring that events, player movements, and object movements occurring simultaneously are positioned in the same column within the embedding chart. The embedding chart may be unwound from the two-dimensional grid structure into a linear sequence arranged consecutively, where each embedding may be assigned a numerical identifier for attention mechanism operations. The conversion from the two-dimensional embedding chart to the linear sequence may be performed automatically as part of data preparation for transformer-based processing by transformer neural network 804.

Event decoder 806 may receive the predictive outputs from transformer neural network 804. Event decoder 806 may decode the predictive outputs to generate the response 208. The response 208 may indicate likelihoods of events occurring during the sporting occasion, as described previously. Event decoder 806 may output probability distributions over the EQL vocabulary tokens, enabling multi-modal language model 124 to answer queries about event categories, teams, players, targets, and outcomes.

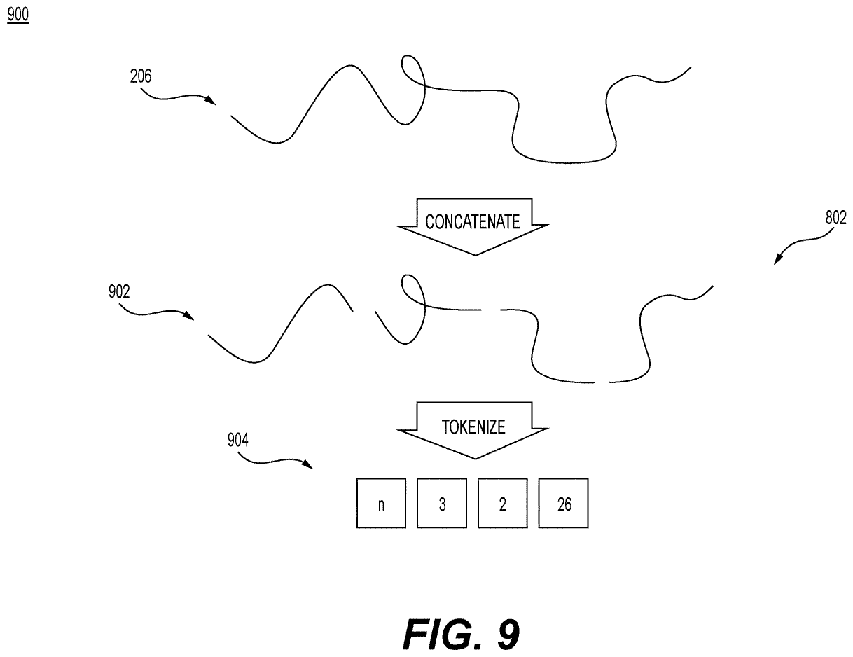

FIG. 9 depicts a tokenization process 900, according to example embodiments. Tokenization process 900 illustrates how tracking data 206 is processed by track encoder 802 to generate a set of tracklets 902 and output tokens 904. As described previously, track encoder 802 may partition the tracking data 206 into time-based tracklets, where each tracklet of the time-based tracklets may represent movement patterns over a predetermined time interval.

Track encoder 802 may implement a Vector-Quantized Variational Autoencoder (VQ-VAE) architecture to perform pattern matching operations between input tracklets and codebook entries. The VQ-VAE architecture may receive the set of tracklets 902 as input and may generate output tokens 904 by matching each tracklet to entries in a codebook. The codebook may contain a plurality of movement shapes, where each movement shape may be associated with a unique numeric identifier. Track encoder 802 may tokenize the tracklets by matching each tracklet to entries in the codebook to generate numeric identifiers representing the movement patterns.

The VQ-VAE architecture may perform pattern matching using Euclidean distance calculations. For each tracklet in the set of tracklets 902, track encoder 802 may compute the Euclidean distance between the encoded representation of the tracklet and each entry in the codebook. The codebook entry with the smallest Euclidean distance to the encoded tracklet representation may be selected as the matching entry. The unique numeric identifier associated with the selected codebook entry may be assigned to the tracklet, generating the corresponding output token in output tokens 904.

Track encoder 802 may incorporate a commitment loss mechanism that encourages the encoder to produce representations close to codebook vectors while simultaneously updating codebook entries to better represent the distribution of encoded tracklets. The commitment loss mechanism may include two components: a vector quantization loss and a commitment loss. The vector quantization loss may encourage codebook entries to move closer to the encoded representations assigned to them. The commitment loss may encourage the encoder to produce representations that are close to the codebook entries, preventing the encoded representations from growing arbitrarily far from the codebook vectors.

Track encoder 802 may implement an exponential moving average update rule for codebook vectors. Each codebook entry may be gradually adjusted based on encoded representations assigned to the codebook entry during training. The exponential moving average update rule may compute a weighted average between the current codebook vector and the mean of encoded representations assigned to that codebook entry. The weighting may be controlled by a decay parameter that determines how quickly the codebook vectors adapt to new encoded representations. The exponential moving average update rule may provide stable training dynamics by preventing abrupt changes to codebook vectors while allowing the codebook to adapt to the distribution of encoded tracklets over time.

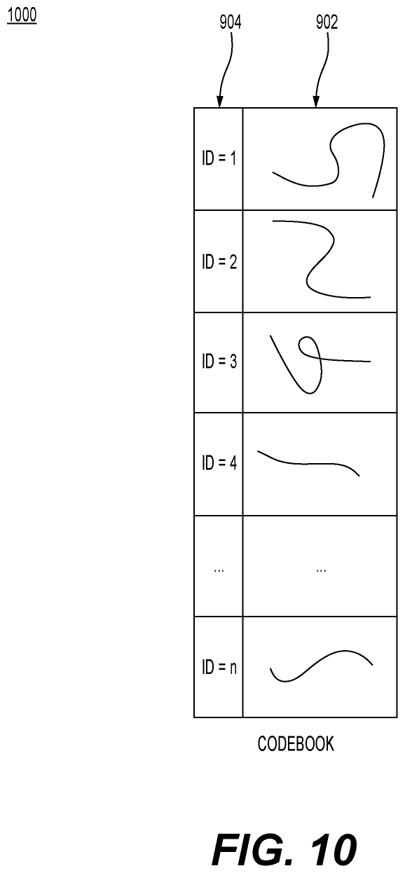

FIG. 10 depicts a codebook 1000, according to example embodiments. Codebook 1000 may contain a plurality of movement shapes, where each of the plurality of movement shapes may be associated with a unique numeric identifier. As shown in FIG. 10, codebook 1000 may include numeric identifiers (e.g., 0, 1, 2, 3, 4, 5, 6, 7, etc.) and corresponding tracklet shapes representing movement patterns from an overhead perspective. Each tracklet shape in codebook 1000 may represent a distinct movement pattern that players or objects may exhibit during a sporting occasion. The movement patterns may include linear movements, curved trajectories, stationary positions, acceleration patterns, deceleration patterns, and directional changes. Codebook 1000 may incorporate spatial information related to the area of the playing field where tracklets occur, providing additional context for the movement patterns beyond the trajectory characteristics alone. In some embodiments, the area of the field where tracklets occur may be stored separately from the tracklet shape, allowing the system to maintain distinct representations for movement patterns and spatial locations. This approach may enable the system to distinguish between similar movement patterns that occur in different areas of the playing field, such as a curved run near the goal versus a similar curved run at midfield. In other embodiments, the area of the field may be incorporated directly into codebook 1000 as part of the tracklet shape representation, creating location-specific movement patterns where each entry represents both the trajectory characteristics and the spatial context of the movement. For example, codebook 1000 may contain separate entries for forward runs that occur in the attacking third versus forward runs that occur in the defensive third, even if the trajectory patterns are similar. The incorporation of spatial information into codebook 1000 may enhance the semantic meaning of the generated tokens and improve the accuracy of subsequent analysis and prediction tasks.

Codebook 1000 may be generated using k-means clustering applied to training datasets containing historical tracking data from historical sporting occasions. The k-means clustering algorithm may partition the historical tracking data into a predetermined number of clusters, where each cluster may represent a distinct movement pattern. During the generation of codebook 1000, tracklets from the historical tracking data may be initially randomly assigned to clusters. The tracklets may then be iteratively updated to move toward the center of identified clusters. The iterative update process may continue until the cluster assignments stabilize or a maximum number of iterations is reached. The center of each cluster may become an entry in codebook 1000, representing a prototypical movement pattern for that cluster.

The k-means clustering process may involve computing the centroid of each cluster based on the tracklets assigned to that cluster. For each iteration, each tracklet may be reassigned to the cluster whose centroid is closest to the tracklet based on Euclidean distance. After reassignment, the centroids may be recomputed based on the updated cluster memberships. The iterative process may minimize the within-cluster variance, resulting in codebook entries that represent the most common movement patterns observed in the historical tracking data.

A separate codebook may be generated for ball movement. Ball movement may be considered distinct from player movement due to unique movement characteristics exhibited by the ball during sporting occasions. The separate codebook for ball movement may capture unique movement characteristics such as higher velocities compared to player movements. The separate codebook for ball movement may also capture erratic trajectory changes that may occur when the ball is kicked, headed, or deflected. The separate codebook for ball movement may further capture physics-based behaviors including bouncing, rolling, compression, rotation, and aerial flight paths. By maintaining a separate codebook for ball movement, track encoder 802 may more accurately tokenize ball trajectories that exhibit movement patterns distinct from player movements.

The separate codebook for ball movement may be generated using k-means clustering applied to ball tracking data from historical sporting occasions. The ball tracking data may include trajectories that exhibit the unique characteristics of ball movement, such as rapid acceleration when kicked, deceleration due to friction when rolling, parabolic trajectories during aerial flight, and abrupt direction changes upon contact with players or the playing surface. The k-means clustering algorithm may identify clusters of ball movement patterns that represent these distinct behaviors, and the cluster centers may form the entries in the separate codebook for ball movement.

As described previously, transformer neural network 804 may apply an attention mechanism to the tokenized tracklets, the query tokens, and the event tokens to generate predictive outputs. The attention mechanism may selectively apply attention weights between the tokenized tracklets, the query tokens, and the event tokens based on temporal proximity and entity relationships. The selective application of attention weights may enable transformer neural network 804 to focus on relevant portions of the input sequence when generating predictions while avoiding computational overhead associated with attending to all possible token pairs.

Applying the attention mechanism may comprise applying sliding window attention along temporal sequences within defined time windows. The sliding window attention may constrain each embedding to attend to other embeddings within a limited temporal range rather than attending to all embeddings in the sequence. The sliding window attention may limit each embedding to attend only to embeddings within defined time windows, creating sparse attention matrices where only relevant embedding pairs within the temporal window receive non-zero attention weights. Attention weights for embedding pairs outside the defined time window may be masked and set to zero, preventing attention between temporally distant embeddings. This masking approach may eliminate the need to compute and store complete attention matrices, reducing computational complexity while maintaining the ability to capture temporal dependencies between nearby events and movements. By limiting the attention range to defined time windows, the sliding window attention may reduce computational complexity while maintaining the ability to capture temporal dependencies between nearby events and movements.

The attention mechanism may incorporate temporal window constraints that limit the range of embeddings to which each embedding may attend. Event embeddings may attend to other events within approximately two hundred seconds of the particular timestamp associated with the event embedding. The two hundred-second temporal window constraint may enable event embeddings to capture relationships between events that occur in temporal proximity while preventing attention to events that are temporally distant and may be less relevant to the prediction task. The temporal window constraint may be implemented by masking attention weights for event pairs that fall outside the two hundred-second window, causing the softmax operation to produce attention weights of approximately zero for those pairs.

Applying the attention mechanism may further comprise applying dense attention to facilitate interactions between the tokenized tracklets, the query tokens, and the event tokens at specific time-steps. The dense attention may allow embeddings within the same temporal column to attend to each other without the temporal window constraints applied to cross-temporal attention. Dense attention may refer to intra-frame attention applied between all entities (e.g., player, object, and events) that occur concurrently as applied densely (i.e., each entity attends to every other entity) for a particular time stamp. At each specific time-step, the dense attention may enable player embeddings, ball embeddings, and event embeddings to interact and exchange information, capturing the spatial relationships and interactions that exist at that moment in the sporting occasion.

Player embeddings may apply selective attention that focuses on embeddings representing other players, events, and the ball within the same temporal column. The selective attention for player embeddings may avoid attention to past or future embeddings of other players. By avoiding attention to past or future embeddings of other players, the selective attention mechanism may prevent information leakage across time while still allowing player embeddings to attend to their own past and future embeddings. The selective attention mechanism may be implemented by masking attention weights between player embeddings and other player embeddings at different time-steps, while allowing attention between player embeddings and event embeddings, ball embeddings, and the same player's embeddings at other time-steps within the defined temporal window.

The combination of sliding window attention and dense attention may enable transformer neural network 804 to capture both temporal dependencies along sequences and spatial interactions at specific time-steps. The sliding window attention may capture how events and movements evolve over time within the defined time windows. The dense attention may capture how players, the ball, and events interact with each other at each moment in the sporting occasion. Together, these attention mechanisms may enable transformer neural network 804 to generate predictive outputs that account for both the temporal dynamics and spatial configurations of the sporting occasion.

As described previously, event decoder 806 may decode the predictive outputs generated by transformer neural network 804. The decoding process may convert the predictive outputs into probability distributions over EQL tokens, enabling multi-modal language model 124 to generate responses indicating likelihoods of events occurring during the sporting occasion.

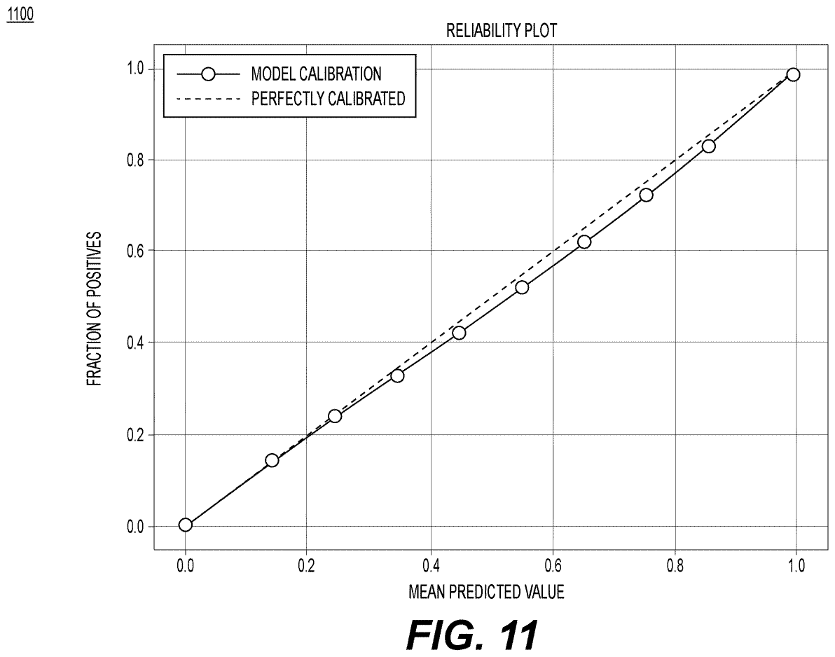

FIG. 11 depicts a graph of a reliability plot 1100, according to example embodiments. The graph of a reliability plot 1100 may be used to evaluate the calibration of multi-modal language model 124 by comparing the alignment between predicted probabilities and actual outcomes observed in a test set.

The graph of a reliability plot 1100 may include a horizontal axis representing predicted probabilities and a vertical axis representing empirical frequencies. The predicted probabilities may be grouped into multiple probability bins, where each bin may contain predictions falling within a specific probability range. For each probability bin, the empirical frequency may be computed as the proportion of predictions in that bin where the predicted event actually occurred. A line of perfect calibration may be displayed on the graph of a reliability plot 1100, where the line of perfect calibration may represent the ideal case where predicted probabilities exactly match empirical frequencies.

Multi-modal language model 124 may demonstrate calibration by closeness to the line of perfect calibration displayed on the graph of a reliability plot 1100. When the plotted points representing the relationship between predicted probabilities and empirical frequencies fall close to the line of perfect calibration, multi-modal language model 124 may be considered well-calibrated. A well-calibrated model may produce predicted probabilities that accurately reflect the true likelihood of events occurring. For example, if multi-modal language model 124 predicts that an event has a 70% probability of occurring, a well-calibrated model would exhibit approximately 70% of such predictions resulting in the event actually occurring.

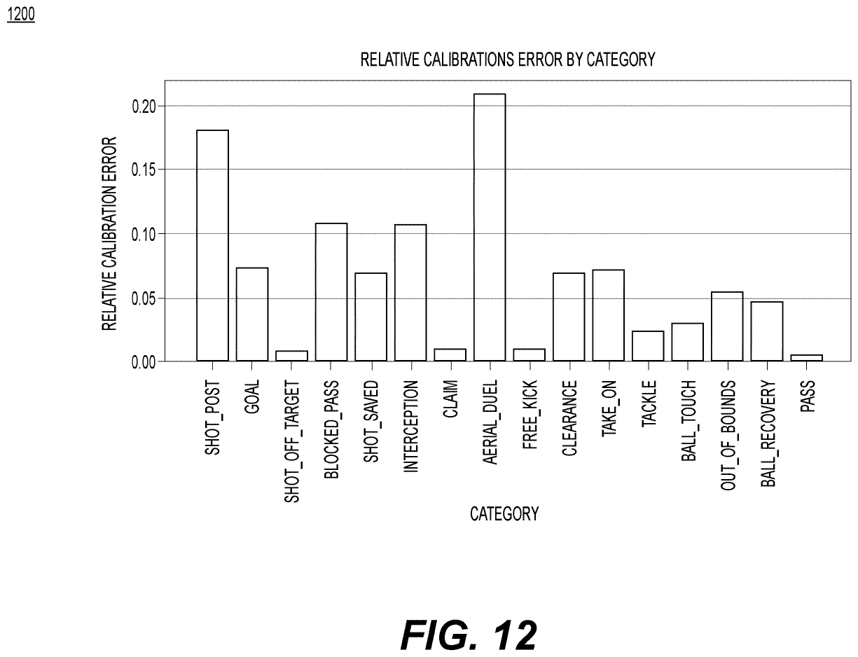

FIG. 12 depicts a graph 1200 of relative calibration error by category, according to example embodiments. The graph 1200 of relative calibration error by category may display the relative calibration error (RCE) for each token in the category class of the EQL vocabulary. The RCE metric may compute the relative difference between the number of predicted instances of a token and the actual count over a test set. The graph 1200 of relative calibration error by category may provide a detailed view of how well multi-modal language model 124 calibrates predictions across different event categories.

The graph 1200 of relative calibration error by category may display RCE values for each of the 16 event category tokens in the EQL vocabulary. The event category tokens may include pass, ball recovery, out-of-bounds, ball touch, tackle, take on, clearance, free kick, aerial duel, claim, interception, shot saved, blocked pass, shot off target, goal, and shot post. Each bar in the graph 1200 of relative calibration error by category may represent the RCE value for a corresponding event category token, enabling comparison of calibration performance across different event types.

The variance in RCE across tokens may be attributed to the imbalanced nature of category tokens in the training and evaluation data. Pass events may contribute to over 70% of tokens in the dataset. The predominance of pass events may cause multi-modal language model 124 to be trained primarily on pass-related patterns, potentially resulting in less accurate calibration for less frequent event categories. Event categories that occur infrequently, such as aerial duels and shots hitting the post, may have fewer training examples available for multi-modal language model 124 to learn accurate probability estimates.

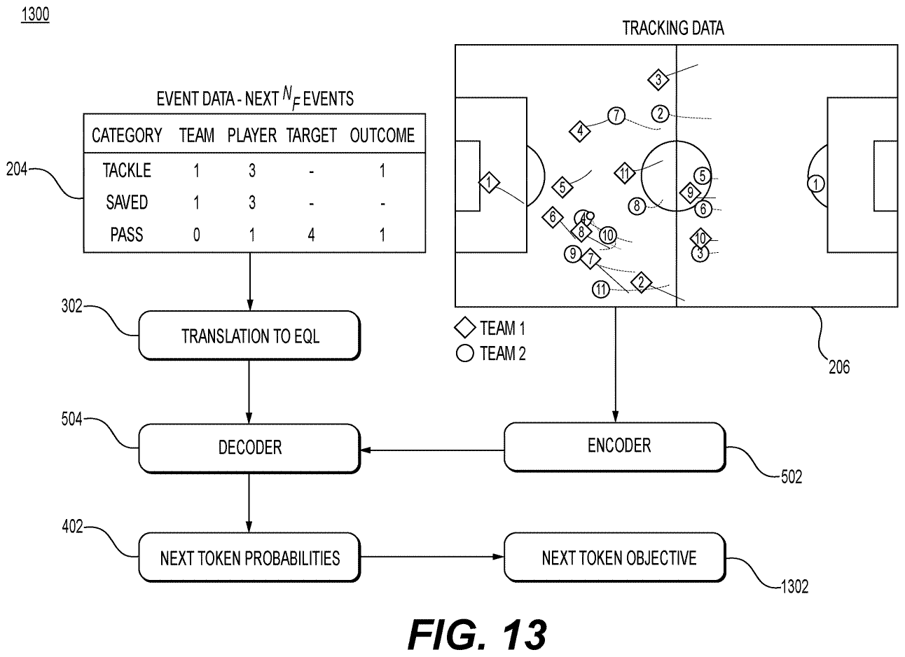

FIG. 13 depicts a block diagram 1300 of training a multi-modal language model, according to example embodiments. The block diagram 1300 of training a multi-modal language model illustrates how multi-modal language model 124 may be trained using event data 204, tracking data 206, and next token objectives 1302. As described previously, event data 204 may be related to events occurring during the sporting occasion, and tracking data 206 may provide position information including x,y coordinates of one or more agents and x,y coordinates of one or more objects during the sporting occasion.

Multi-modal language model 124 may be trained using a next token prediction task. During training, the N_{P} previous events and the NF next events may be converted into an EQL token sequence Y=(y₁, . . . , y_{L}). In the EQL token sequence, the first L_{P} tokens may describe previous events and may be used as optional warmup context. The EQL token sequence Y may represent one or more training tokens used as a training prompt. The training tokens may include tokens representing event identifiers, team identifiers, player identifiers, target identifiers, and outcome identifiers, as described previously with respect to EQL prompt 302.

The block diagram 1300 of training a multi-modal language model includes a next token objective 1302. The next token objective 1302 may define the training objective for multi-modal language model 124. The next token objective 1302 may be defined as:

$$maximize {\sum }_{l = {L}_{P}}^{L} log P ( {y}_{l} \vert X , {y}_{1 : l - 1} )$$

where Y=(y₁, . . . , y_{L}) represents one or more training tokens used as a training prompt, X represents at least part of the tracking data feed (e.g., tracking data 206), and L_{P} represents a number of training tokens in Y that represent past event context. The next token objective 1302 may use maximum likelihood loss over the EQL tokens that represent future events.

Multi-modal language model 124 may condition on the sequence of preceding tokens and the previous T frames of tracking data 206 when predicting the next token. The conditioning on tracking data 206 may enable multi-modal language model 124 to incorporate fine-grained spatiotemporal context when generating predictions.

During training, spatiotemporal encoder 502 may receive tracking data 206 and generate encoded representations of the spatiotemporal context. Transformer decoder 504 may receive the EQL prompt 302 and the encoded representations from spatiotemporal encoder 502. Transformer decoder 504 may generate next token predictions 402, which may represent the predicted probability distributions over the EQL vocabulary for each position in the sequence.

The next token objective 1302 may compute the log probability of each ground truth token y₁ given the tracking data X and all preceding tokens y_{1:1-1}. The summation in the next token objective 1302 may begin at position L_{P}, which represents the number of training tokens that represent past event context. By beginning the summation at position L_{P}, the next token objective 1302 may compute the loss over the EQL tokens that represent future events while using the past event tokens as context.

Organization computing system 104 may process the tracking data feed to identify interactions between the one or more agents and the one or more objects. Based on the interactions, organization computing system 104 may determine a likelihood of a first event occurring and a likelihood of a second event occurring. Organization computing system 104 may compare the likelihood of the first event occurring and the likelihood of the second event occurring. Based on the comparing, organization computing system 104 may identify that the first event is more likely occurring than the second event. Based on the identifying, organization computing system 104 may adjust weights of a machine learning model (e.g., multi-modal language model 124) that determines the likelihood of events occurring.

The weight adjustment process may involve computing gradients of the next token objective 1302 with respect to the model parameters. The gradients may indicate how the model parameters should be adjusted to increase the log probability of the ground truth tokens. An optimizer (e.g., the Adam optimizer) may use the computed gradients to update the weights of multi-modal language model 124. The weight updates may be performed iteratively over training examples until multi-modal language model 124 converges to a state where the next token predictions 402 accurately reflect the likelihoods of events occurring in the sporting occasion.

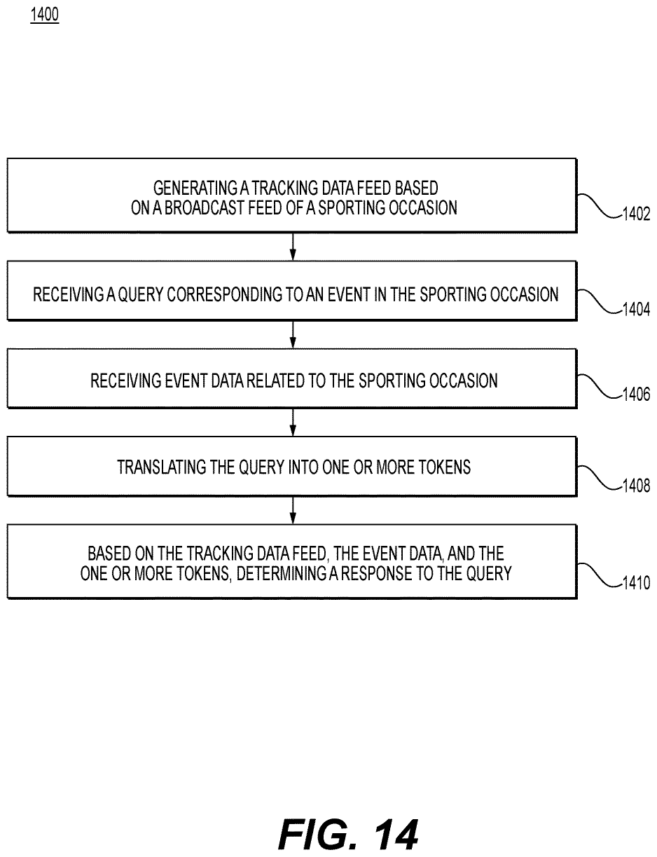

FIG. 14 depicts a process 1400 for generating query responses, according to example embodiments. Process 1400 may be performed by organization computing system 104 to answer predictive questions about future events in a sporting occasion.

At a first step 1402, organization computing system 104 may generate a tracking data feed based on a broadcast feed of a sporting occasion. The tracking data feed may have position information including x,y coordinates of one or more agents and x,y coordinates of one or more objects. The position information of one or more agents and one or more objects from the broadcast feed may be projected onto a two-dimensional playing surface including the x,y coordinates.

At a second step 1404, organization computing system 104 may receive a query 202 corresponding to an event in the sporting occasion. The query 202 may comprise natural language generated by a user operating client device 108 via the application 130. The query 202 may be transmitted to organization computing system 104 via the network 105 for processing by multi-modal language model 124.

At a third step 1406, organization computing system 104 may receive event data 204 related to the sporting occasion. As described previously, event data 204 may include information about on-ball actions such as passes, tackles, interceptions, shots, and other events that occur during the sporting occasion.

At a fourth step 1408, organization computing system 104 may translate the query 202 into one or more tokens. Organization computing system 104 may convert the query 202 from natural language into the Event Query Language (EQL) by parsing the query to identify relevant event attributes such as event categories, team identifiers, player identifiers, target identifiers, and outcome identifiers. The one or more tokens may form an EQL prompt 302, which may provide a standardized structure for expressing queries as sequences of discrete language tokens.

At a fifth step 1410, organization computing system 104 may determine a response 208 to the query 202 based on the tracking data feed, the event data 204, and the one or more tokens. The response 208 may be based on a likelihood of the event occurring.

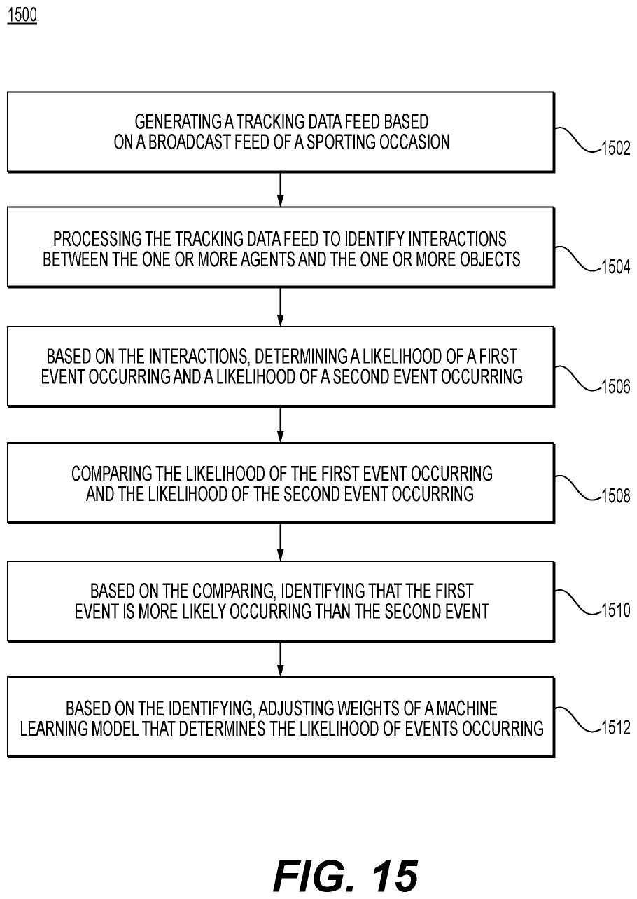

FIG. 15 depicts a process 1500 for training a multi-modal language model to generate query responses, according to example embodiments. Process 1500 may be performed by organization computing system 104 to train multi-modal language model 124 to determine likelihoods of events occurring during a sporting occasion.

At a first step 1502, organization computing system 104 may generate a tracking data feed based on a broadcast feed of a sporting occasion. As described previously, the tracking data feed may have position information including x,y coordinates of one or more agents and x,y coordinates of one or more objects.

At a second step 1504, organization computing system 104 may process the tracking data feed to identify interactions between the one or more agents and the one or more objects. The processing may involve analyzing the position information to detect spatial relationships, movement patterns, and temporal dynamics between players and the ball during the sporting occasion.

At a third step 1506, organization computing system 104 may determine a likelihood of a first event occurring and a likelihood of a second event occurring based on the interactions. Organization computing system 104 may determine a likelihood of the event occurring based on the tracking data feed and the one or more tokens.

At a fourth step 1508, organization computing system 104 may compare the likelihood of the first event occurring and the likelihood of the second event occurring. The comparison may involve evaluating the probability values associated with each event to determine which event has a higher likelihood of occurring based on the current game state represented partially by the tracking data feed.

At a fifth step 1510, organization computing system 104 may identify that the first event is more likely occurring than the second event based on the comparing. For example, organization computing system 104 may identify that a pass to a first player positioned closer to the ball carrier has a higher probability of succeeding than a pass to a second player positioned farther away.

At a sixth step 1512, organization computing system 104 may adjust weights of a machine learning model that determines the likelihood of events occurring based on the identifying. The weight adjustment may involve computing gradients of the training objective with respect to model parameters and updating the weights of multi-modal language model 124 to improve future predictions. The adjusted weights may enable multi-modal language model 124 to more accurately predict likelihoods of events occurring in subsequent sporting occasions.

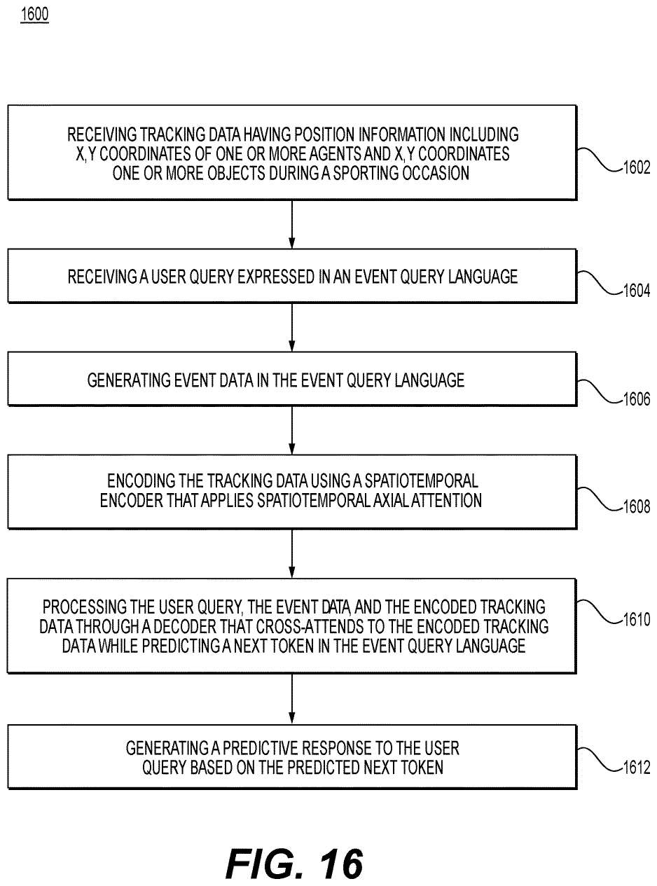

FIG. 16 depicts a process 1600 for processing tracking data to identify interactions and generate responses, according to example embodiments. Process 1600 may be performed by organization computing system 104 to answer predictive questions about future events in a sporting occasion using spatiotemporal encoding and cross-attention mechanisms.

At a first step 1602, organization computing system 104 may receive tracking data having position information including x,y coordinates of one or more agents and x,y coordinates of one or more objects during a sporting occasion. As described previously, the tracking data may be generated based on a broadcast feed of the sporting occasion, where the position information of one or more agents and one or more objects from the broadcast feed may be projected onto a two-dimensional playing surface including the x,y coordinates.

At a second step 1604, organization computing system 104 may receive a user query expressed in an Event Query Language. As described previously, the Event Query Language may comprise a tokenized language with discrete language tokens representing event attributes.

At a third step 1606, organization computing system 104 may generate event data in the Event Query Language.

At a fourth step 1608, organization computing system 104 may encode the tracking data using a spatiotemporal encoder that applies spatiotemporal axial attention. As described previously, the spatiotemporal axial attention may identify how the one or more agents and how the one or more objects move over time and how the one or more agents and how the one or more objects interact.

At a fifth step 1610, organization computing system 104 may process the user query, the event data, and the encoded tracking data through a decoder that cross-attends to the encoded tracking data while predicting a next token in the Event Query Language. The decoder may incorporate the tracking context by cross-attending to the output of the spatiotemporal encoder. The cross-attention mechanism may allow the decoder to selectively attend to relevant portions of the encoded tracking data when generating each token prediction.

At a sixth step 1612, organization computing system 104 may generate a predictive response to the user query based on the predicted next token. The response 208 may indicate likelihoods of events occurring during the sporting occasion.

The systems and methods described herein may be applied to multiple sports beyond soccer. The sporting occasion may be one of a soccer sporting occasion, basketball sporting occasion, football sporting occasion, cricket sporting occasion, badminton sporting occasion, volleyball sporting occasion, etc. The architecture of multi-modal language model 124 may generalize across sports with different event types, player configurations, playing surfaces, and game dynamics. The generalization may be achieved by adapting the Event Query Language vocabulary to include sport-specific event categories, player identifiers, and outcome types while maintaining the underlying spatiotemporal encoding and transformer-based prediction mechanisms.

For basketball sporting occasions, multi-modal language model 124 may predict end of possession outcomes. The event categories for basketball may include shot attempts, passes, dribbles, turnovers, rebounds, steals, blocks, fouls, and free throws. The player identifier in basketball may have options corresponding to the five on-court positions for each team, with additional identifiers for substituted players. Multi-modal language model 124 may receive tracking data specifying the two-dimensional positions of players and the ball on the basketball court and may generate predictions regarding the outcome of the current possession. For example, multi-modal language model 124 may predict whether the possession will result in a made shot, a missed shot, a turnover, or a foul. The predictions may further specify the player most likely to take the shot, the probability of the shot being successful, and the expected point value of the possession.

For American football sporting occasions, multi-modal language model 124 may predict outcomes for the next down. The event categories for American football may include pass plays, run plays, sacks, interceptions, fumbles, touchdowns, field goals, punts, and penalties. The player identifier in American football may correspond to the eleven on-field positions for each team, with additional identifiers for substituted players. Multi-modal language model 124 may receive tracking data specifying the two-dimensional positions of players and the ball on the football field and may generate predictions regarding the outcome of the next down. For example, multi-modal language model 124 may predict whether the next play will be a pass or a run, the expected yards gained, the probability of a first down conversion, and the likelihood of a turnover. The predictions may further specify the intended receiver of a pass, the probability of a completion, and the expected yards after catch.

For cricket sporting occasions, multi-modal language model 124 may generate and predict outcomes for next events. The event categories for cricket may include deliveries, runs scored, wickets, boundaries, extras, and dismissal types. The player identifier in cricket may correspond to the batsman, bowler, and fielding positions. Multi-modal language model 124 may receive tracking data specifying the positions of players and the ball on the cricket pitch and may generate predictions regarding the outcome of the next delivery. For example, multi-modal language model 124 may predict the type of delivery (e.g., pace, spin, yorker, bouncer), the runs likely to be scored, the probability of a wicket falling, and the likelihood of a boundary.

For tennis sporting occasions, multi-modal language model 124 may predict the next shot and related outcomes. The event categories for tennis may include serves, returns, forehands, backhands, volleys, lobs, drop shots, aces, double faults, and winners. The player identifier in tennis may correspond to the two players in a singles match or the four players in a doubles match. Multi-modal language model 124 may receive tracking data specifying the positions of players and the ball on the tennis court and may generate predictions regarding the next shot. For example, multi-modal language model 124 may predict the type of shot the player will execute, the placement of the shot on the court, the probability of the shot being a winner, and the likelihood of an unforced error.

For badminton sporting occasions, multi-modal language model 124 may predict shot types and rally outcomes. The event categories for badminton may include serves, clears, drops, smashes, drives, net shots, and lifts. The player identifier in badminton may correspond to the players in singles or doubles configurations. Multi-modal language model 124 may receive tracking data specifying the positions of players and the shuttlecock on the badminton court and may generate predictions regarding the next shot and the probability of winning the rally.

For volleyball sporting occasions, multi-modal language model 124 may predict play outcomes and player actions. The event categories for volleyball may include serves, passes, sets, attacks, blocks, digs, and aces. The player identifier in volleyball may correspond to the six on-court positions for each team, including setter, outside hitter, middle blocker, opposite hitter, and libero. Multi-modal language model 124 may receive tracking data specifying the positions of players and the ball on the volleyball court and may generate predictions regarding the outcome of the current rally, the player most likely to attack, and the probability of a successful kill.

The systems and methods described herein may be applicable to both live sporting occasions and recorded sporting occasions. For live sporting occasions, organization computing system 104 may receive tracking data in real-time or near real-time from tracking system 102 and may generate responses 208 as the sporting occasion unfolds. The real-time predictions may enable applications such as live commentary assistance, in-game strategy recommendations, and dynamic content generation. For recorded sporting occasions, organization computing system 104 may process historical tracking data to generate responses 208 for analysis, training, and entertainment purposes. The recorded sporting occasion analysis may enable applications such as post-game review, player performance evaluation, and historical match comparison.

Organization computing system 104 may present the response 208 in a portal. The response 208 may include a description of the event and a description of a second event. For example, the response 208 may include an event that corresponds to a player scoring, and a second event that corresponds to the player passing. The portal may display the response 208 in a graphical user interface that includes textual descriptions, probability values, visual representations of player positions, and predicted movements.

Organization computing system 104 may receive real-time or near real-time bids for a predicted occurrence of either the event or the second event. Organization computing system 104 may identify a winning user of a plurality of users based on the real-time or near real-time bids. The real-time or near real-time bids may be associated with market predictions regarding the outcome of events during the sporting occasion.

The response 208 generated by multi-modal language model 124 may trigger various actions and outputs based on predicted events. Organization computing system 104 may trigger advertisements, graphics, highlights, or animations based on the response 208. For example, when multi-modal language model 124 predicts a high probability of a goal-scoring opportunity, organization computing system 104 may trigger a graphical overlay highlighting the attacking player and the predicted shot trajectory. When multi-modal language model 124 predicts a high probability of a defensive interception, organization computing system 104 may trigger an animation showing the predicted interception point and the subsequent counter-attack path.

Based on the response 208, organization computing system 104 may stop a market prediction. When the predicted event likelihood reaches a threshold, organization computing system 104 may suspend or close markets associated with that event. For example, when multi-modal language model 124 predicts that a goal has a probability exceeding a predetermined threshold (e.g., 90%), organization computing system 104 may automatically suspend markets related to the next goal scorer or the match outcome. The market suspension may occur before the event is officially confirmed, providing protection against information asymmetry and ensuring market integrity.

Organization computing system 104 may perform integrity monitoring for detecting anomalous patterns. The integrity monitoring may compare predicted event likelihoods generated by multi-modal language model 124 with observed market activity. When market activity deviates from the predicted likelihoods by more than a threshold amount, organization computing system 104 may flag the activity as potentially anomalous. For example, if multi-modal language model 124 predicts that a particular player has a low probability of scoring, but market activity indicates substantial interest in that player scoring, organization computing system 104 may generate an alert for further investigation.

Organization computing system 104 may implement per-query monetization. The system 104 may charge per query for visual question answering functionality, monetizing the predictive question answering capability. Users may submit queries 202 through application 130 on client device 108, and organization computing system 104 may track the number of queries 202 submitted by each user. Organization computing system 104 may charge users based on the number of queries 202 submitted, the complexity of the queries 202, or the type of sporting occasion being analyzed. The per-query monetization model may enable organization computing system 104 to generate revenue from the predictive question answering capability while providing users with flexible access to the system.

Based on the response 208, organization computing system 104 may switch to one of a first video stream or a second video stream. The response 208 may trigger switching between video streams in a multi-game broadcast environment based on predicted exciting events. For example, when multi-modal language model 124 predicts a high probability of a scoring opportunity in a first sporting occasion, organization computing system 104 may switch the broadcast feed from a second sporting occasion to the first sporting occasion. The multi-stream switching may enable viewers to watch the most exciting moments across multiple concurrent sporting occasions without missing high-probability scoring opportunities.

Organization computing system 104 may focus a sub-broadcast on a specific player based on the query 202 and response 208. The system 104 may allow users to watch the main broadcast while also viewing a player-specific feed. For example, a user may submit a query 202 requesting predictions related to a particular player, and organization computing system 104 may generate a sub-broadcast that tracks that player throughout the sporting occasion. The player-focused sub-broadcast may display the player's position, movements, predicted actions, and probability of involvement in upcoming events. The sub-broadcast may be displayed alongside the main broadcast in a picture-in-picture configuration or in a separate viewing window.

Multi-modal language model 124 may predict not just future events but also current events. The current event prediction capability may enable automated event detection and captioning of ongoing gameplay. For example, multi-modal language model 124 may analyze tracking data in real-time to detect when a pass has occurred, when a shot has been taken, or when a tackle has been made. The detected events may be automatically captioned and displayed to viewers, providing real-time commentary without human annotation. The automated event detection may also be used to generate event data for subsequent predictions, creating a feedback loop where detected events inform future predictions.

Multi-modal language model 124 may autoregressively sample event sequences to simulate action sequences that follow an event. The autoregressive sampling may facilitate deeper understanding of potential outcomes by generating multiple possible future scenarios. For example, given a current game state, multi-modal language model 124 may sample a sequence of events representing one possible future trajectory, then sample another sequence representing an alternative future trajectory. By generating multiple sampled sequences, organization computing system 104 may provide users with a distribution of possible outcomes rather than a single point prediction. The autoregressive sampling may be used to evaluate the expected value of different player decisions, assess the risk associated with different strategies, and simulate the longer-term impacts of player actions.

Multi-modal language model 124 may support visual prompting that enables retrieval and analysis of moments from match databases based on complex query criteria. For example, the visual prompting capability may enable users to find moments where the object on the right side of the pitch has two or more attackers and both teams engaged in a press. The visual prompting capability may identify complex tactical scenarios based on spatial relationships, player configurations, and team engagement patterns captured through the comprehensive processing of tracking data and event information throughout complete matches. In some embodiments, organization computing system 104 may present results showing similar play scenarios with field visualizations that depict player configurations, contextual information about specific play characteristics and tactical elements, and performance metrics and statistical measures associated with each play scenario. The visual prompting capability may enable coaches and analysts to identify similar play scenarios from extensive match databases and understand tactical patterns that develop across different games and contexts.

Organization computing system 104 may generate ghosting predictions that display predicted future player locations on a playing surface representation. The ghosting predictions may enable visualization of potential player movements and strategic positioning scenarios. For example, organization computing system 104 may display a representation of the playing surface with current player positions shown as solid markers and predicted future positions shown as semi-transparent markers (ghosts). The ghosting predictions may show where players are expected to move over the next several seconds based on the current game state and predicted events. The ghosting predictions may be used by coaches and analysts to evaluate player positioning, identify defensive vulnerabilities, and plan offensive strategies.

Organization computing system 104 may generate ghosting predictions that display predicted future player locations on a playing surface representation. The ghosting predictions may enable visualization of potential player movements and strategic positioning scenarios. For example, organization computing system 104 may display a representation of the playing surface with current player positions shown as solid markers and predicted future positions shown as semi-transparent markers (ghosts). The ghosting predictions may show where players are expected to move over the next several seconds based on the current game state and predicted events. The ghosting predictions may be used by coaches and analysts to evaluate player positioning, identify defensive vulnerabilities, and plan offensive strategies. The ghosting predictions may also display where players should have been positioned to prevent a particular event from occurring. This counterfactual ghosting capability may enable analysis of defensive positioning errors, missed coverage assignments, and strategic improvements by showing optimal player locations that could have prevented goals, successful passes, or other events. The counterfactual ghosting predictions may be presented in video formats or static visualizations comparing actual player positions with recommended positions.

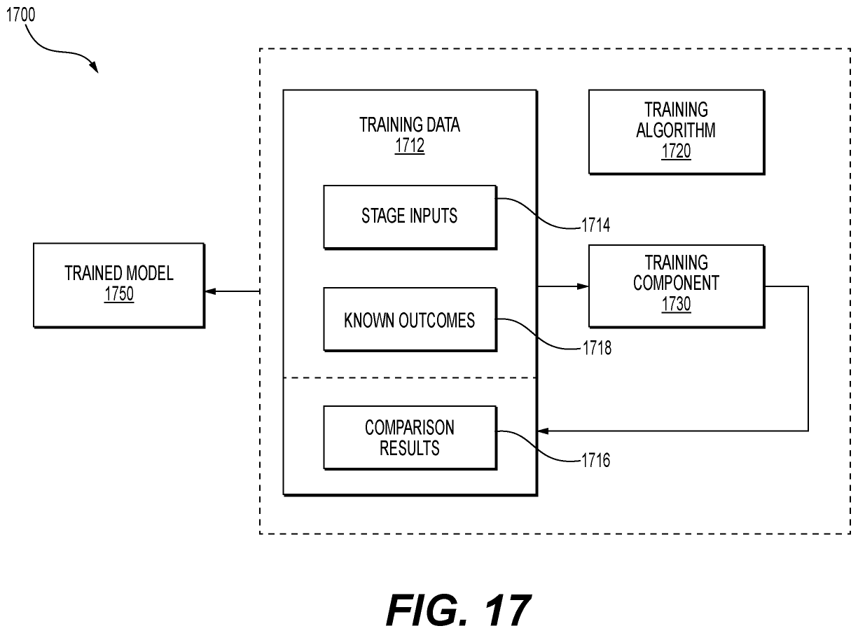

FIG. 17 depicts a flow diagram 1700 for training a machine-learning model, in accordance with an aspect of the disclosed subject matter. As shown in flow diagram 1700 of FIG. 17, training data 1712 may include one or more of stage inputs 1714 and known outcomes 1718 related to a machine learning model to be trained. The stage inputs 1714 may be from any applicable source including a component or set shown in the figures provided herein. The known outcomes 1718 may be included for machine learning models generated based on supervised or semi-supervised training. An unsupervised machine learning model might not be trained using known outcomes 1718. Known outcomes 1718 may include known or desired outputs for future inputs similar to or in the same category as stage inputs 1714 that do not yet have known outcomes.

The training data 1712 and a training algorithm 1720 may be provided to a training component 1730 that may apply the training data 1712 to the training algorithm 1720 to generate a trained machine learning model 1750. According to an implementation, the training component 1730 may be provided comparison results 1716 that compare a previous output of the corresponding machine learning model to apply the previous result to re-train the machine learning model. The comparison results 1716 may be used by the training component 1730 to update the corresponding machine learning model. The training algorithm 1720 may utilize machine learning networks and/or models including but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1700 may be a trained machine learning model 1750.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

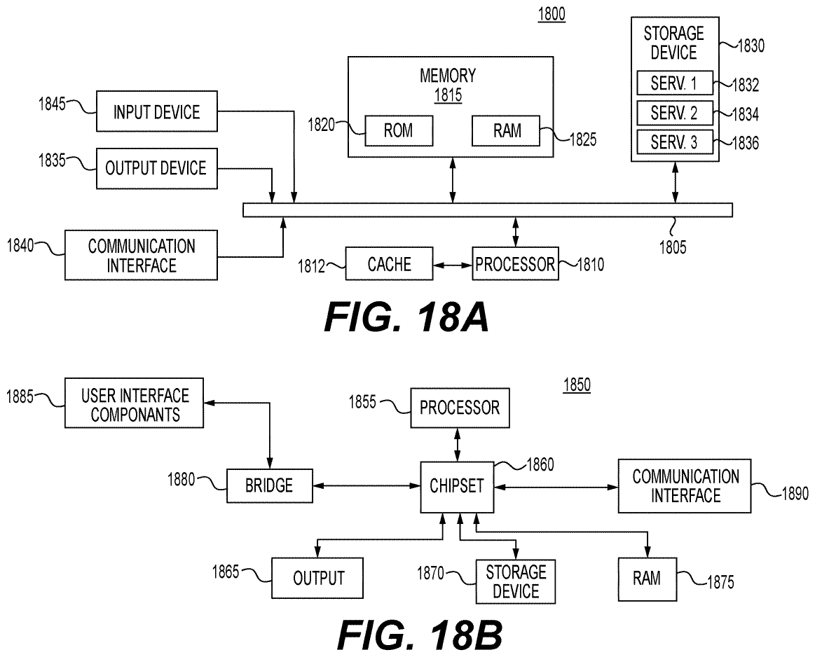

FIG. 18A illustrates an architecture of computing system 1800, according to example embodiments. System 1800 may be representative of at least a portion of organization computing system 104. One or more components of the system 1800 may be in electrical communication with each other using a bus 1805. The system 1800 may include a processing unit (CPU or processor) 1810 and a system bus 1805 that couples various system components including the system memory 1815, such as read only memory (ROM) 1820 and random access memory (RAM) 1825, to the processor 1810. The system 1800 may include a cache of high-speed memory connected directly with, in close proximity to, or integrated as part of the processor 1810. The system 1800 may copy data from the memory 1815 and/or storage device 1830 to cache 1812 for quick access by the processor 1810. In this way, the cache 1812 may provide a performance boost that avoids the processor 1810 delays while waiting for data. These and other modules may control or be configured to control the processor 1810 to perform various actions. Other system memory 1815 may be available for use as well. The memory 1815 may include multiple different types of memory with different performance characteristics. The processor 1810 may include any general purpose processor and a hardware module or software module, such as service 1 1832, service 2 1834, and service 3 1836 stored in the storage device 1830, configured to control the processor 1810 as well as a special-purpose processor where software instructions are incorporated into the actual processor design. The processor 1810 may essentially be a completely self-contained computing system, containing multiple cores or processors, a bus, memory controller, cache, etc. A multi-core processor may be symmetric or asymmetric.

To enable user interaction with the computing system 1800, an input device 1845 may represent any number of input mechanisms, such as a microphone for speech, a touch-sensitive screen for gesture or graphical input, keyboard, mouse, motion input, speech and so forth. An output device 1835 (e.g., display) may also be one or more of a number of output mechanisms known to those of skill in the art. In some instances, multimodal systems may enable a user to provide multiple types of input to communicate with the computing system 1800. Communications interface 1840 may generally govern and manage the user input and system output. There is no restriction on operating on any particular hardware arrangement and therefore the basic features here may easily be substituted for improved hardware or firmware arrangements as they are developed.

The storage device 1830 may be a non-volatile memory and may be a hard disk or other types of computer readable media which may store data that are accessible by a computer, such as magnetic cassettes, flash memory cards, solid state memory devices, digital versatile disks, cartridges, the random access memories (RAMs) 1825, the read only memory (ROM) 1820, and hybrids thereof.

The storage device 1830 may include the services 1832, 1834, and 1836 for controlling the processor 1810. Other hardware or software modules are contemplated. The storage device 1830 may be connected to the system bus 1805. In one aspect, a hardware module that performs a particular function may include the software component stored in a computer-readable medium in connection with the necessary hardware components, such as the processor 1810, the bus 1805, the output device 1835, and so forth, to carry out the function.

FIG. 18B illustrates a computer system 1850 having a chipset architecture that may represent at least a portion of the organization computing system 104. The computer system 1850 may be an example of computer hardware, software, and firmware that may be used to implement the disclosed technology. The system 1850 may include a processor 1855, representative of any number of physically and/or logically distinct resources capable of executing software, firmware, and hardware configured to perform identified computations. The processor 1855 may communicate with a chipset 1860 that may control input to and output from the processor 1855. In this example, the chipset 1860 outputs information to output 1865, such as a display, and may read and write information to storage device 1870, which may include magnetic media, and solid-state media, for example. The chipset 1860 may also read data from and write data to RAM 1875. A bridge 1880 for interfacing with a variety of user interface components 1885 may be provided for interfacing with the chipset 1860. Such user interface components 1885 may include a keyboard, a microphone, touch detection and processing circuitry, a pointing device, such as a mouse, and so on. In general, inputs to the system 1850 may come from any of a variety of sources, machine generated and/or human generated.

The chipset 1860 may also interface with one or more communication interfaces 1890 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by the processor 1855 analyzing data stored in the storage device 1870 or the RAM 1875. Further, the machine may receive inputs from a user through the user interface components 1885 and execute appropriate functions, such as browsing functions by interpreting these inputs using the processor 1855.

It may be appreciated that the example systems 1800 and 1850 may have more than one processor 1810 or be part of a group or cluster of computing devices networked together to provide greater processing capability.

A number of implementations have been described. Nevertheless, it will be understood that various modifications may be made without departing from the spirit and scope of the disclosure. Accordingly, other implementations are within the scope of the following claims.

1. A computing system for generating query responses, the system comprising:
a processor; and
memory storing instructions that, when executed by the processor, cause the processor to perform acts comprising:
generating, by the computing system, a tracking data feed based on a broadcast feed of a sporting occasion, the tracking data feed having position information including x,y coordinates of one or more agents and x,y coordinates of one or more objects, wherein the position information of one or more agents and one or more objects from the broadcast feed is projected onto a two-dimensional playing surface including the x,y coordinates;
receiving, by the computing system, a query corresponding to an event in the sporting occasion;
receiving, by the computing system, event data related to the sporting occasion;
translating, by the computing system, the query into one or more tokens; and
based on the tracking data feed, the event data, and the one or more tokens, determining, by the computing system, a response to the query, wherein the response is based on a likelihood of the event occurring.

2. The computing system of claim 1, wherein the query includes at least one of an event identifier, a team identifier, a player identifier, a target identifier, and an outcome identifier.

3. The computing system of claim 2, wherein the one or more tokens further include tokens representing at least one of the event identifier, the team identifier, the player identifier, the target identifier, and the outcome identifier.

4. The computing system of claim 3, wherein the one or more tokens include a start of sequence (SOS) token and an end of sequence (EOS) token.

5. The computing system of claim 1, wherein the query comprises natural language generated by a user.

6. The computing system of claim 1, wherein the processor further performs acts comprising:
receiving, by the computing system, a second query corresponding to the event;
translating, by the computing system, the second query into one or more tokens; and
based on the tracking data feed and the one or more tokens, determining, by the computing system, a second response to the query, wherein the second response is based on the likelihood of the event occurring and a feature related to the event, the feature being one of a player, a team, a target, and an outcome.

7. The computing system of claim 6, wherein the processor further performs acts comprising:
receiving, by the computing system, a third query corresponding to the event;
translating, by the computing system, the third query into one or more tokens; and
based on the tracking data feed and the one or more tokens, determining, by the computing system, a third response to the query, wherein the third response is based on the likelihood of the event occurring and a second feature related to the event, the second feature being one of a player, a team, a target, and an outcome.

8. The computing system of claim 1, wherein the one or more tokens represent numerical values.

9. A computer-implemented method for generating query responses, comprising:
generating a tracking data feed based on a broadcast feed of a sporting occasion, the tracking data feed having position information including x,y coordinates of one or more agents and x,y coordinates one or more objects, wherein the position information of one or more agents and one or more objects from the broadcast feed is projected onto a two-dimensional playing surface including the x,y coordinates;
receiving a query corresponding to an event in the sporting occasion;
receiving event data related to the sporting occasion;
translating the query into one or more tokens; and
based on the tracking data feed, the event data, and the one or more tokens, determining a response to the query, wherein the response is based on a likelihood of the event occurring.

10. The computer-implemented method of claim 9, wherein the query includes at least one of an event identifier, a team identifier, a player identifier, a target identifier, and an outcome identifier.

11. The computer-implemented method of claim 10, wherein the one or more tokens further include tokens representing at least one of the event identifier, the team identifier, the player identifier, the target identifier, and the outcome identifier.

12. The computer-implemented method of claim 11, wherein the one or more tokens include a start of sequence (SOS) token and an end of sequence (EOS) token.

13. The computer-implemented method of claim 9, further comprising:
receiving a second query corresponding to the event;
translating the second query into one or more tokens; and
based on the tracking data feed and the one or more tokens, determining a second response to the query, wherein the second response is based on the likelihood of the event occurring and a feature related to the event, the feature being one of a player, a team, a target, and an outcome.

14. The computer-implemented method of claim 13, further comprising:
receiving a third query corresponding to the event;
translating the third query into one or more tokens; and
based on the tracking data feed and the one or more tokens, determining a third response to the query, wherein the third response is based on the likelihood of the event occurring and a second feature related to the event, the second feature being one of a player, a team, a target, and an outcome.

15. A non-transitory computer readable medium configured to store processor-readable instructions, wherein when executed by a processor, the instructions perform operations comprising:
generating a tracking data feed based on a broadcast feed of a sporting occasion, the tracking data feed having position information including x,y coordinates of one or more agents and x,y coordinates one or more objects, wherein the position information of one or more agents and one or more objects from the broadcast feed is projected onto a two-dimensional playing surface including the x,y coordinates;
receiving a query corresponding to an event in the sporting occasion;
receiving event data related to the sporting occasion;
translating the query into one or more tokens; and
based on the tracking data feed, the event data, and the one or more tokens, determining a response to the query, wherein the response is based on a likelihood of the event occurring.

16. The non-transitory computer readable medium of claim 15, wherein the query includes at least one of an event identifier, a team identifier, a player identifier, a target identifier, and an outcome identifier.

17. The non-transitory computer readable medium of claim 16, wherein the one or more tokens further include tokens representing at least one of the event identifier, the team identifier, the player identifier, the target identifier, and the outcome identifier.

18. The non-transitory computer readable medium of claim 17, wherein the one or more tokens include a start of sequence (SOS) token and an end of sequence (EOS) token.

19. The non-transitory computer readable medium of claim 15, wherein the processor further performs acts comprising:
receiving a second query corresponding to the event;
translating the second query into one or more tokens; and
based on the tracking data feed and the one or more tokens, determining a second response to the query, wherein the second response is based on the likelihood of the event occurring and a feature related to the event, the feature being one of a player, a team, a target, and an outcome.

20. The non-transitory computer readable medium of claim 19, wherein the processor further performs acts comprising:
receiving a third query corresponding to the event;
translating the third query into one or more tokens; and
based on the tracking data feed and the one or more tokens, determining a third response to the query, wherein the third response is based on the likelihood of the event occurring and a second feature related to the event, the second feature being one of a player, a team, a target, and an outcome.
